(19) United States
(12) Patent Application Publication
(10) Pub. No.: US 2026/0368309 A1
(43) Pub. Date: Nov. 19, 2026

(54) ADAPTIVE SYSTEM AND METHOD FOR DETECTING AND DIAGNOSING CODE INJECTION ATTACKS

(71) Applicant: Georgia Tech Research Corporation, Atlanta, GA (US)

(72) Inventors: Zheng YANG, Atlanta, GA (US); Wenke LEE, Atlanta, GA (US); Pak Ho CHUNG, Atlanta, GA (US); Brendan D. SALTAFORMAGGIO, Atlanta, GA (US); Jizhou CHEN, Atlanta, GA (US); Runze ZHANG, Atlanta, GA (US)

(21) Appl. No.: 19/650,932

(22) Filed: Apr. 17, 2026

Related U.S. Application Data
(60) Provisional application No. 63/790,682, filed on Apr. 17, 2025.

(51) Int. Cl. G06F 21/54; G06F 21/55

(52) U.S. Cl. CPC G06F 21/54; G06F 21/554

(57) ABSTRACT

An exemplary system and method are disclosed that provide rapid, tamper-proof, and comprehensive mitigation against code injection attacks in software, web, and computer applications on a client device or application prior to execution via protectable enforcement of an abstract syntax tree (AST). In another aspect, an exemplary system and method are disclosed that facilitate the identification of the exact injection point of code injection attacks after application execution, using information derived from the client device or application.

### RELATED APPLICATION

This application claims priority to, and the benefit of, U.S. Provisional Patent Application No. 63/790,682, filed Apr. 17, 2025, entitled “AUTOMATED CUSTOMIZABLE WEB APPLICATION FOR REDUCED ATTACK SURFACE USING ADAPTIVE SECURITY MECHANISMS,” which is incorporated by reference herein in its entirety.

### GOVERNMENT SPONSORSHIP CLAUSE

This invention was made with government support under N66001-21-C-4024, awarded by the Defense Advanced Research Projects Agency (DARPA), under N00014-19-1-2179, awarded by the Office of Naval Research, and under 2229876, awarded by the National Science Foundation. The government has certain rights in the invention.

### BACKGROUND

Many software applications rely on interpreted or just-in-time-compiled programming languages that provide event-driven execution and runtime code generation to support functionality across web, server, and desktop environments.

Unintended execution can arise when malicious code is injected into executable contexts, leading to various security risks, such as modifications in control flow, misuse of privileged functionality, or execution of code outside the developer's original intent. Program behavior can be complex, leading to unintended or unsafe code execution that can be exploited by malicious code. Examples of such program behaviors include, but are not limited to, asynchronous callbacks, dynamically constructed functions, inter-process communication, and inputs from external or semi-trusted sources. The security risks can be further amplified in applications that integrate multiple execution contexts or bridge higher-level application logic with lower-level system capabilities.

There is a benefit to detecting, preventing, and diagnosing code injection attacks in JavaScript-based and other interpreted or just-in-time-compiled programming-language applications.

### SUMMARY

An exemplary system and method are disclosed that provide rapid, tamper-proof, and comprehensive mitigation against code injection attacks in software, web, and computer applications on a client device or application prior to execution via protectable enforcement of an abstract syntax tree (AST). In another aspect, an exemplary system and method are disclosed that facilitate the identification of the exact injection point of code injection attacks after application execution, using information derived from the client device or the application. The identification can be performed on the client device, application, or in a separate remote application. In some implementations, the exemplary system and method can provide both (i) rapid, tamper-proof, and comprehensive mitigation against code injection attacks in software, web, and computer applications prior to the application execution, and (ii) identification of the exact injection point of the code injection attacks after the application execution in a single platform.

In some implementations, the exemplary system and method enforce abstract syntax tree (AST) structural integrity and execution context constraints to prevent injected code from executing, and reconstruct reduced program representations (e.g., self-contained program) using symbolic analysis to localize injection points after execution. The exemplary system and method can provide both proactive prevention of code-injection attacks and accurate, actionable root-cause identification when such attacks are detected.

In contrast to code injection defenses that detect anomalous behavior at execution sinks or validate inputs using localized checks, exemplary system and method enforce program integrity at the language abstraction level by validating abstract syntax tree (AST) structure and execution context prior to execution. This approach can (i) prevent various code injection attacks, including those involving dynamically generated code, by blocking semantic deviations rather than relying on signature matching, taint propagation, or post-hoc enforcement, and (ii) provide centralized, tamper-proof protection across execution contexts within an application program.

In contrast to diagnostic approaches that provide limited visibility into dynamic, asynchronous, or event-driven execution, the exemplary system and method reconstruct a reduced, vulnerability-preservation program representation (e.g., self-contained program) from a detected execution event and apply symbolic analysis to recover attacker-controlled data flow and control-flow decisions. This approach can enable localization of an injection point within application programs that involve dynamic code generation, cross-event execution, or inter-process communication, without requiring whole-program symbolic execution, complete source-level assumptions, or manual forensic analysis.

In an aspect, a non-transitory computer-readable medium having instructions stored thereon for a protection module configured to execute the instructions in a computer script interpretative engine (e.g., JavaScript engine) is disclosed, wherein the execution of the instructions, triggered when the computer script interpretative engine loads a computer script of an application program, causes a processor to: prior to execution of the computer script by the computer script interpretative engine, receive a runtime abstract syntax tree (AST) profile of the computer script, wherein the runtime AST profile includes a runtime AST structure associated with a set of runtime metadata (e.g., execution context values, e.g., URL, caller, etc.); select a learned AST profile from a candidate set of learned AST profiles, wherein each of the candidate set of learned AST profiles includes a learned AST structure associated with a set of learned metadata, by matching (i) one or more metadata in the set of learned metadata of the learned AST profile with (ii) respective one or more metadata in the set of runtime metadata of the runtime AST profile; compare (i) the runtime AST structure of the runtime AST profile and (ii) the learned AST structure of the selected learned AST profile; and initiate or block execution of the computer script by the computer script interpretative engine based on the comparison.

In some embodiments, the execution of the instructions further causes the processor to trigger a diagnostic operation to identify an entry point of an injection attack.

In some embodiments, each of the runtime AST structure and the selected learned AST structure includes a set of nodes and a set of edges connecting the nodes, wherein the set of nodes includes (i) one or more executable-logic nodes, each representing an executable operation within the computer script, and/or (ii) one or more data nodes, each representing a data value within the computer script.

In some embodiments, the execution of the instructions, during the comparison, causes the processor to: compare (i) each executable-logic node of the runtime AST structure to a respective executable-logic node of the selected learned AST structure, and (ii) each data node of the runtime AST structure to a respective data node of the selected learned AST structure; block the execution of the computer script by the computer script interpretative engine in response to: a data node in the runtime AST structure and a respective data node in the selected learned AST structure representing data values of different data types; an executable-logic node in the runtime AST structure and a respective executable-logic node in the selected learned AST structure representing different executable operations; a data or executable-logic node in the runtime AST structure having a different number or arrangement of neighboring nodes (e.g., children) from a respective data or executable-logic node in the selected learned AST structure.

In some embodiments, the execution of the instructions, in response to no learned AST profiles from the candidate set of learned AST profiles being selected, causes the processor to: receive a predefined set of security policies; and initiate or block execution of the computer script by the computer script interpretative engine based on the received predefined set of security policies.

In some embodiments, the set of runtime metadata specifies at least: an execution environment (e.g., execution context) for the computer script interpretative engine to execute the computer script therein, a process in which the computer script interpretative engine loads the computer script, or a combination thereof.

In some embodiments, the received predefined set of security policies includes a first security policy (e.g., zero-trust execution policy) causing the processor to block the execution of the computer script when the execution environment provides the computer script interpretative engine with access to an operating system of a host device of the computer script interpretative engine.

In some embodiments, the received predefined set of security policies includes a second security policy (e.g., origin-based policy) causing the processor to block the execution of the computer script when an origin identifier associated with a runtime metadata mismatches a predefined origin identifier.

In some embodiments, the received predefined set of security policies includes a third security policy causing the processor to block the execution of the computer script when one or more variables within the computer script utilize resources outside the computer script (e.g., a non-locally defined variable).

In some embodiments, the candidate set of learned AST profiles was generated by parsing a set of computer scripts without executing the set of computer scripts (e.g., static profiling).

In some embodiments, the candidate set of learned AST profiles was further generated using runtime AST profiles generated by executions of the set of computer scripts (e.g., dynamic profiling).

In some embodiments, the processor blocks the execution of the computer script by causing the computer script interpretative engine to return a non-operative function.

In another aspect, a system is disclosed comprising: a processor; and a memory having instructions stored thereon for a protection module configured to execute the instructions in a computer script interpretative engine (e.g., JavaScript engine), wherein the execution of the instructions, triggered when the computer script interpretative engine loads a computer script of an application program, causes the processor to: prior to execution of the computer script by the computer script interpretative engine, receive a runtime abstract syntax tree (AST) profile of the computer script, wherein the runtime AST profile includes a runtime AST structure associated with a set of runtime metadata (e.g., execution context values, e.g., URL, caller, etc.); select a learned AST profile from a candidate set of learned AST profiles, wherein each of the candidate set of learned AST profiles includes a learned AST structure associated with a set of learned metadata, by matching (i) one or more metadata in the set of learned metadata of the learned AST profile with (ii) respective one or more metadata in the set of runtime metadata of the runtime AST profile; compare (i) the runtime AST structure of the runtime AST profile and (ii) the learned AST structure of the selected learned AST profile; and initiate or block execution of the computer script by the computer script interpretative engine based on the comparison.

In some embodiments, each of the runtime AST structure and the selected learned AST structure includes a set of nodes and a set of edges connecting the nodes, wherein the set of nodes includes (i) one or more executable-logic nodes, each representing an executable operation within the computer script, and/or (ii) one or more data nodes, each representing a data value within the computer script.

In some embodiments, the execution of the instructions, during the comparison, causes the processor to: compare (i) each executable-logic node of the runtime AST structure to a respective executable-logic node of the selected learned AST structure, and (ii) each data node of the runtime AST structure to a respective data node of the selected learned AST structure; block the execution of the computer script by the computer script interpretative engine in response to: a data node in the runtime AST structure and a respective data node in the selected learned AST structure representing data values of different data types; an executable-logic node in the runtime AST structure and a respective executable-logic node in the selected learned AST structure representing different executable operations; or a data or executable-logic node in the runtime AST structure having a different number or arrangement of neighboring nodes (e.g., children) from a respective data or executable-logic node in the selected learned AST structure.

In some embodiments, the execution of the instructions, in response to no learned AST profiles from the candidate set of learned AST profiles being selected, causes the processor to: receive a predefined set of security policies; and initiate or block execution of the computer script by the computer script interpretative engine based on the received predefined set of security policies.

In some embodiments, the candidate set of learned AST profiles was generated by parsing a set of computer scripts without executing the set of computer scripts (e.g., static profiling).

In some embodiments, the candidate set of learned AST profiles was further generated using runtime AST profiles generated by executions of the set of computer scripts (e.g., dynamic profiling).

In another aspect, a method for protecting a computer script interpretative engine prior to executing a computer script of an application program is disclosed comprising: receiving a runtime abstract syntax tree (AST) profile of the computer script, wherein the runtime AST profile includes a runtime AST structure associated with a set of runtime metadata (e.g., execution context values, e.g., URL, caller, etc.); selecting a learned AST profile from a candidate set of learned AST profiles, wherein each of the candidate set of learned AST profiles includes a learned AST structure associated with a set of learned metadata, by matching (i) one or more metadata in the set of learned metadata of the learned AST profile with (ii) respective one or more metadata in the set of runtime metadata of the runtime AST profile; comparing (i) the runtime AST structure of the runtime AST profile and (ii) the learned AST structure of the selected learned AST profile; and initiating or blocking execution of the computer script by the computer script interpretative engine based on the comparison.

In yet another aspect, a non-transitory computer-readable medium (e.g., on a diagnostic computer) to diagnose an application program during a runtime execution of the application program by a computer script interpretative engine (e.g., JavaScript Engine) is disclosed, the computer-readable medium having instructions stored thereon, wherein execution of the instructions causes a processor to: generate, in a first execution environment, an activity log of execution events invoked by function calls during the runtime execution of the application program; in response to detecting a code injection attack (e.g., Synode) during a partial execution path of the application program in the computer script interpretative engine, wherein the partial execution path of the application program generated a first call stack trace, reconstruct, in a second execution environment, a second call stack trace representing a full execution path of the application program, wherein the second call stack trace is reconstructed by correlating the generated activity log with the first call stack trace captured at a point of detection of the code injection attack; generate, in the second execution environment, a self-contained application program of the application program, wherein the self-contained application program is generated based on the second call stack trace; execute, in the second execution environment, the self-contained application program to obtain a quarantined execution path; determine, via a root cause analysis operation (e.g., trace analysis operation), a program-entry point of the code injection attack in the quarantined execution path; and output a diagnostic report (e.g., root cause report) that includes the program-entry point of the code injection attack in the quarantined execution path.

In some embodiments, the generated activity log captures, for each execution event, at least one of an event type, a payload identifier, a location in the application program that invoked the event, an identifier of the first call stack trace, and an identifier of a callback function for the execution event.

In some embodiments, the execution of the instructions causes, during the reconstruction of the second call stack trace, the processor to: identify, based on the second call stack trace, functions (e.g., JavaScript functions) associated with the self-contained application program; determine, based on the second call stack trace, variables and function calls associated with each of the identified functions; generate a symbolic value (e.g., placeholder value) for every missing variable or function calls associated with each of the identified functions; and determine, based on the second call stack trace, a logical execution flow between the identified functions, wherein the second call stack trace is configured to maintain a correspondence between every function associated with the application program and a respective function associated with the self-contained application program.

In some embodiments, the execution of the instructions further causes the processor to: in response to the root cause analysis operation not being able to determine the program-entry point of the code injection attack, iteratively re-execute the self-contained application program, until the program-entry point of the code injection attack is determined.

In some embodiments, the execution of the instructions causes, during the root cause analysis operation, the processor to: identify a value in the quarantined execution path, wherein the identified value is derived from an execution event in the activity log and associated with the application program; traverse the quarantined execution path backward, starting from the point of detection of the code injection attack, to trace propagation of the identified value along the quarantined execution path; and identify, as the program-entry point of the code injection attack, a location in the quarantined execution path at which the identified value is first inserted into the quarantined execution path.

In some embodiments, the execution of the instructions further causes the processor to: iteratively rewrite, via a trained AI model, the self-contained application program until no program-entry points of the code injection attack are determined.

### BRIEF DESCRIPTION OF DRAWINGS

FIGS. 1A and 1B each show an example system for providing rapid, tamper-proof, and comprehensive mitigation against code injection attacks in software, web, and computer applications on a client device or application prior to execution via protectable enforcement of an abstract syntax tree (AST), in accordance with an illustrative embodiment.

FIG. 1C shows an example system for (i) identifying a point of injection of a code injection attack on an execution of the computer script or program, and (ii) generating a diagnostic report based on the identification, in addition to employing a protection module shown in FIGS. 1A-1, in accordance with an illustrative embodiment.

FIGS. 1D and 1E each show an example diagnosis module, employed by the system in FIG. 1C, configured to monitor an execution of the computer script or program, identify the point of code injection during the execution, and generate the diagnostic report based on the identification, in accordance with an illustrative embodiment.

FIG. 2A shows an example method for verifying a computer script or program prior to execution and blocking the computer script or program from being executed by a computer script interpretative engine if the computer script or program is malicious, in accordance with an illustrative embodiment.

FIG. 2B shows an example method for identifying a point of injection of a code injection attack on a script or program execution, in accordance with an illustrative embodiment.

FIG. 3A shows an example operational flow of the exemplary system to defend an application against code injection attacks, in accordance with an illustrative embodiment.

FIG. 3B shows example AST structural signatures of legitimate and malicious code.

FIG. 3C shows an example construction of an AST profile, in accordance with an illustrative embodiment.

FIG. 3D shows an example algorithmic implementation for the exemplary system to select/enforce a learned AST profile, in accordance with an illustrative embodiment.

FIG. 4A shows an example operational flow of the exemplary system to determine, via a diagnosis module, an injection point of a code injection attack, in accordance with an illustrative embodiment.

FIG. 4B shows an example event activity tracking for stack trace recovery in the diagnosis module, in accordance with an illustrative embodiment.

FIG. 4C shows an example operational flow for generating a simplified, self-contained program in the diagnosis module, in accordance with an illustrative embodiment.

FIG. 4D shows an example algorithmic implementation for the diagnosis module to execute the simplified, self-contained program to obtain symbolic execution traces, in accordance with an illustrative embodiment.

FIG. 4E shows an example diagnosis, by the diagnosis module, of the code injection vulnerability CVE-2024-4367 in an application.

FIG. 5A shows an implementation of a first experimental system configured to detect a code injection attack before executing an application, as described in relation to FIG. 1A.

FIG. 5B shows 20 applications vulnerable to code injection and RCE attacks that were used to evaluate the first experimental system.

FIG. 5C shows the details of the collected AST profiles collected from the 20 applications, along with the human effort required for the collection, measured in hours.

FIG. 5D shows the effectiveness of the first experimental system under enforcement.

FIG. 5E shows the runtime overhead of 17 applications, with or without the first experimental system running thereon, during user interaction.

FIG. 6A shows the detection performance of a second experimental system on the SecBench.js dataset, where the second experimental system was configured to (i) detect a code injection attack before executing an application and (ii) determine, via a diagnosis module, a point of injection of a code injection attack, as described in relation to FIG. 1D.

FIG. 6B shows the performance results of the second experimental system to locate injection points of various common vulnerability exploits in real-world applications.

FIG. 6C shows the overhead evaluation results for the second experimental system across various applications.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example Defense System

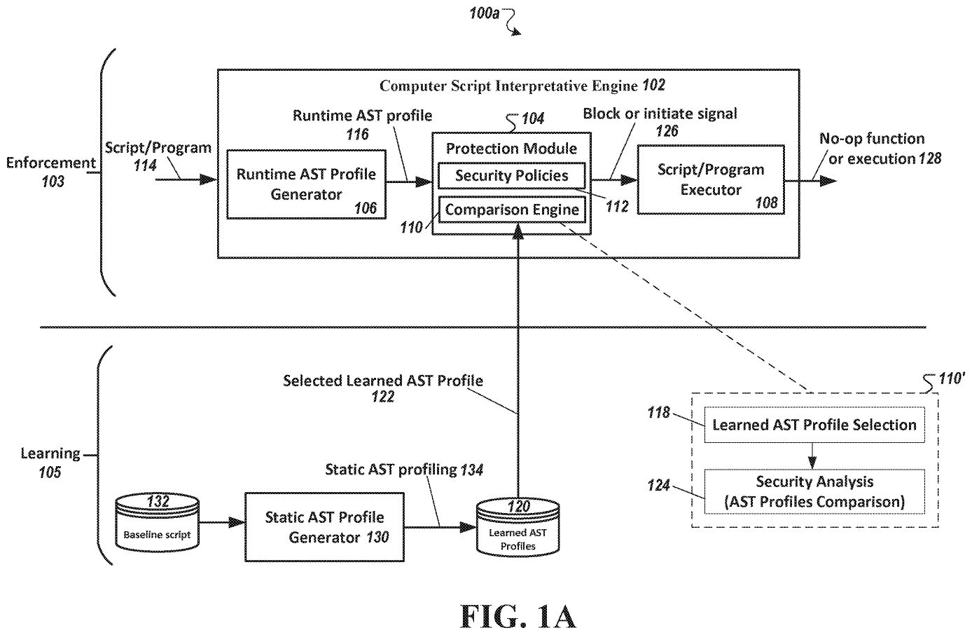

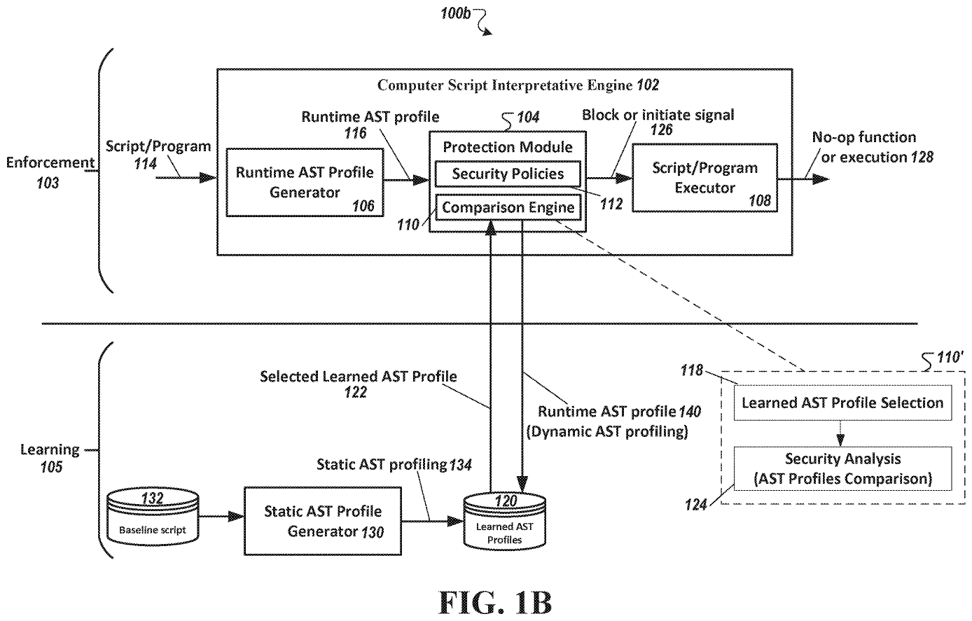

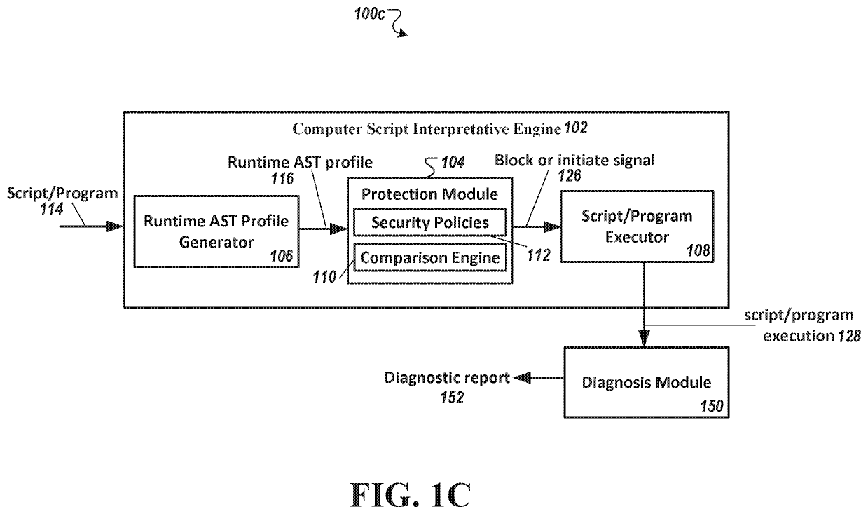

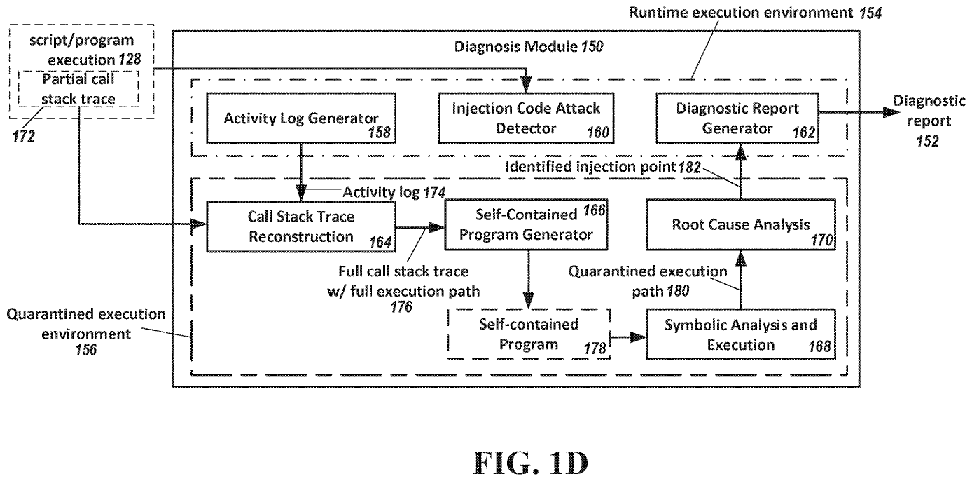

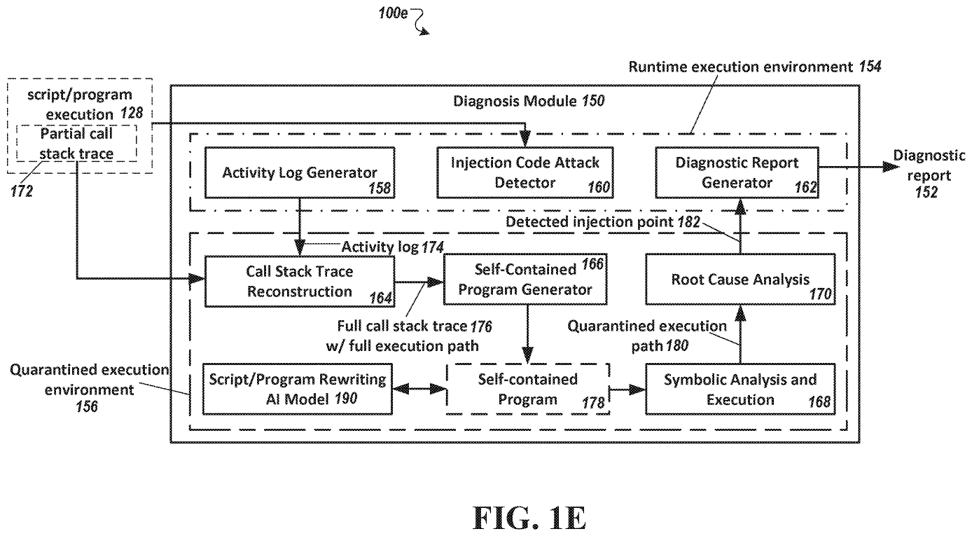

FIGS. 1A and 1B each show an example system for providing rapid, tamper-proof, and comprehensive mitigation against code injection attacks in software, web, and computer applications on a client device or application prior to execution via protectable enforcement of an abstract syntax tree (AST).

In particular, FIGS. 1A and 1B each show an example system 100 (shown as 100a and 100b) for (i) verifying a computer script or program 114 (e.g., application program) prior to execution and (ii) blocking the computer script or program 114 from being executed by a computer script interpretative engine 102 (e.g., JavaScript interpreter, language interpreter) in an execution environment (e.g., 154) if the computer script or program 114 is malicious (e.g., having an injection attack), in accordance with an illustrative embodiment. In FIGS. 1A-1, the interpretative engine 102 includes a protection module 104, a runtime abstract syntax tree (AST) profile generator 106, and a script or program executor 108.

Protection Module (104). In FIGS. 1A-1, the protection module 104, operatively coupled to the runtime AST profile generator 106 and the script or program executor 108, includes a comparison engine 110 (also shown as 110′) and a set of predefined security policies 112. During enforcement 103 (referred to as enforcing phase), when the computer script or program 114 is loaded into the interpretative engine 102, the protection module 104 is configured to receive, via the runtime AST profile generator 106, a runtime AST profile 116 of the computer script or program 114 that can include (i) a runtime AST structure (e.g., 302) associated with (ii) a set of runtime metadata (e.g., 310), such as execution context values (e.g., URL, caller, etc.).

In some embodiments, the set of runtime metadata specifies at least (i) an execution environment (referred to as an execution context) (e.g., 154) for the interpretative engine 102 to execute the computer script or program 114 therein, (ii) a process in which the interpretative engine 102 loads the computer script, or (iii) a combination thereof.

The protection module 104 is then configured to select (118), via the comparison engine 110, a learned AST profile 122 from a candidate set of learned AST profiles 120, by matching (i) one or more metadata in the set of learned metadata of the learned AST profile 122 with (ii) respective one or more metadata in the set of runtime metadata of the runtime AST profile 116. In the candidate set of learned AST profiles 120, each learned AST profile, including the selected learned AST profile 122, can include a learned AST structure associated with a set of learned metadata.

After selecting (118) the learned AST profile 122, the protection module 104 is configured to compare (124), via the comparison engine 110, the runtime AST structure of the runtime AST profile 116 with the learned AST structure of the selected learned AST profile 122. The protection module 104 is then configured to command, via a block or initiate signal 126, the script or program executor 108 to generate a block function (e.g., a no-operative function) or execute the computer script or program 114 (see 128), based on the AST profiles comparison 124.

If no learned AST profiles can be selected (118) from the candidate set of learned AST profiles 120, the protection module 104 is configured to command, via the signal 126, the script or program executor 108 to generate a block function (e.g., a no-operative function) or execute the computer script or program 114 (see 128), based on the predefined set of security policies 112 (e.g., zero-trust execution policy, origin-based policy, data-flow-based policy).

The block function (e.g., a no-operative function) signals users that the computer script or program 114 is blocked from execution by the interpretative engine 102.

AST Profiles Comparison (124). Each of the runtime AST structure and learned AST structure can include a set of nodes and a set of edges connecting the nodes. The set of nodes can include (i) one or more executable-logic nodes, each representing an executable operation within the script or program 114, and/or (ii) one or more data nodes, each representing a data value within the computer script or program 114.

When comparing (124) the runtime AST structure of the runtime AST profile 116 with the learned AST structure of the selected learned AST profile 122, the protection module 104 is configured to first compare, via the comparison engine 110, (i) each executable-logic node of the runtime AST structure with a respective executable-logic node of the learned AST structure, and (ii) each data node of the runtime AST structure to a respective data node of the learned AST structure.

The protection module 104 is then configured to command, via the signal 126, the script or program executor 108 to block the execution of the computer script or program 114 if: (i) a data node in the runtime AST structure and a respective data node in the learned AST structure represent data values of different data types, (ii) an executable-logic node in the runtime AST structure and a respective executable-logic node in the learned AST structure represent different executable operations, or (iii) a data or executable-logic node in the runtime AST structure has a different number or arrangement of neighboring nodes (e.g., children nodes) from a respective data or executable-logic node in the learned AST structure.

Security Policies (112). The protection module 104 is configured to command, via the signal 126, the script or program executor 108 to block the execution of the computer script or program 114, based on a zero-trust execution policy, an origin-based policy, or a data-flow-based policy. In accordance with the zero-trust execution policy, the script or program executor 108 should block the execution of the computer script or program 114 when the execution environment (e.g., 154) can provide the interpretative engine 102 with access to an operating system of a host device (e.g., computer) of the interpretative engine 102.

In accordance with the origin-based policy, the script or program executor 108 should block the execution of the computer script or program 114 when an origin identifier associated with a runtime metadata of the runtime AST profile 116 mismatches a predefined origin identifier.

In accordance with the data-flow-based policy, the script or program executor 108 should block the execution of the computer script or program 114 when one or more variables within the computer script or program 114 utilize resources outside the computer script or program 114 (referred to as non-locally defined variables).

Static AST Profiling (134). In FIG. 1A, during learning 105 (referred to as a learning or profiling phase), the candidate set of learned AST profiles 120 was generated, via a static AST profile generator 130, by parsing, without executing, a baseline set of computer scripts or programs 132.

Dynamic AST Profiling (140). In FIG. 1B, during learning 105, the candidate set of learned AST profiles 120 was further dynamically generated using runtime AST profiles (e.g., 116) produced by executions of computer scripts or programs (e.g., 114), if the computer scripts or programs (e.g., 114) are allowed to be executed by the protection module 104.

### Example Diagnosis System

FIG. 1C shows an example system 100 (shown as 100c) for (i) identifying a point of injection of a code injection attack on a script or program execution, and (ii) generating a diagnostic report 152 based on the identification, in addition to employing the protection module 104 shown in FIGS. 1A-1B, in accordance with an illustrative embodiment. In FIG. 1C, the exemplary system 100 includes a diagnosis module 150 configured to monitor the computer script or program execution 128, identify the point of code injection, and generate the diagnostic report 152 based on the identification. In some embodiments, the diagnosis module 150 is configured to operate in parallel with the interpretative engine 102.

FIGS. 1D and 1E each show the example diagnosis module 150, in accordance with an illustrative embodiment. In FIG. 1D, the diagnosis module 150 includes an activity log generator 158, an injection code attack detector 160, a diagnostic report generator 162, a call stack trace reconstruction module 164, a self-contained program generator 166, a symbolic analysis and execution module 168, and a root cause analysis module 170. In some embodiments, the activity log generator 158, the injection code attack detector 160, and the diagnostic report generator 162 are configured to operate in a runtime execution environment 154. In some embodiments, the call stack trace reconstruction module 164, the self-contained program generator 166, the symbolic analysis and execution module 168, and the root cause analysis module 170 are configured to operate in a quarantined (controlled) execution environment 156.

Runtime Execution Environment (154). In the runtime execution environment 154, the diagnosis module 150 is configured to generate, via the activity log generator 158, an activity log 174 that captures execution events invoked by function calls during the computer script or program execution 128. The diagnosis module 150 is also configured to detect, via the injection code attack detector 160 (e.g., Synode, etc.), a code injection attack during a partial execution path of the computer script or program (e.g., 114).

In some embodiments, the partial execution path of the computer script or program (e.g., 114) generates a partial call stack trace 172. In some embodiments, the activity log 174 captures, for each execution event, at least one of an event type, a payload identifier, a location in the computer script or program (e.g., 114) that invoked the event, an identifier of the partial call stack trace 172, and an identifier of a callback function for the execution event.

When a code injection attack is detected, the activity log generator 158 transmits the activity log 174 to the call stack trace reconstruction module 164 to reconstruct a full call stack trace 176 prior to further operations in the quarantined execution environment 156.

After all operations (e.g., 164, 166, 168, 170) in the quarantined environment 156 are complete, the diagnosis module 150 is configured to generate, via the diagnostic report generator 162, the diagnostic report 152 (also referred to as a root cause report) that includes an identified injection point 182 and associated information.

Quarantined Execution Environment (156). In the quarantined execution environment 156, when the code injection attack is detected, the diagnosis module 150 is configured to reconstruct, via the call stack trace reconstruction module 164, the full call stack trace 176 representing a full execution path of the computer script or program (e.g., 114), by correlating the activity log 174 with the partial call stack trace 172. The diagnosis module 150 is then configured to generate, via the self-contained program generator 166, a self-contained computer program 178 (also referred to as a recomposed, simplified program, or a self-contained application program) of the computer script or program (e.g., 114) based on the full call stack trace 176.

While reconstructing the full call stack trace 176, the call stack trace reconstruction 164 is further configured to (i) identify, based on the full call stack trace 176, functions (e.g., JavaScript functions) associated with the self-contained computer program 178, (ii) determine, based on the full call stack trace 176, variables and function calls associated with each of the identified functions, (iii) generate a symbolic value (e.g., placeholder value) for every missing variable or function calls associated with each of the identified functions, and (iv) determine, based on the full call stack trace 176, a logical execution flow between the identified functions. In some embodiments, the full call stack trace 176 maintains a correspondence between every function associated with the computer script or program being executed (e.g., 114) and a respective function associated with the self-contained computer program 178.

After the self-contained computer program 178 is generated, the diagnosis module 150 is configured to execute, via the symbolic analysis and execution module 168, the self-contained computer program 178 to obtain a quarantined execution path 180. The diagnosis module 150 is then configured to identify, via the root cause analysis module 170 (e.g., trace analysis operation), the injection point 182 (referred to as the program-entry point) of the code injection attack in the quarantined execution path 180, which is then transmitted to the diagnostic report generator 162 to generate the diagnostic report 152.

During the identification of the injection point 182, the root cause analysis module 170 is configured to identify a value in the quarantined execution path 180, which is derived from an execution event in the activity log 174 and associated with the executed computer script or program (e.g., 114). The root cause analysis module 170 is then configured to (i) traverse the quarantined execution path 180 backward, starting from the detection 160 of the code injection attack, to trace propagation of the identified value along the quarantined execution path 180. The root cause analysis module 170 is then configured to identify, as the program-entry point of the code injection attack, a location in the quarantined execution path 180 at which the identified value is first inserted into the quarantined execution path 180.

When the injection point 182 is identified in the quarantined execution path 180 of the self-contained computer program 178, a corresponding injection point in the partial execution path of the executed computer script or program (e.g., 114) can also be identified, because every point (e.g., location) in the quarantined execution path 180 corresponds to a point (e.g., location) in the partial execution path. This is because the full call stack trace 176 maintains the correspondence between the executed computer script or program (e.g., 114) and the self-contained computer program 178.

In some embodiments, the root cause analysis module 170 is not able to identify the injection point 182, so the diagnosis module 150 is configured to iteratively re-execute, via the symbolic analysis and execution 168, the self-contained computer program 178 until the root cause analysis module 170 is able to identify the injection point 182.

In FIG. 1E, the diagnosis module 150 includes a computer script/program rewriting artificial intelligence (AI) model 190, in addition to the operations in the runtime and quarantined execution environment in FIG. 1D. The AI model 190 is configured to iteratively rewrite the self-contained computer program 178 until no program-entry points 182 of the code injection attack are identified.

### Example Method

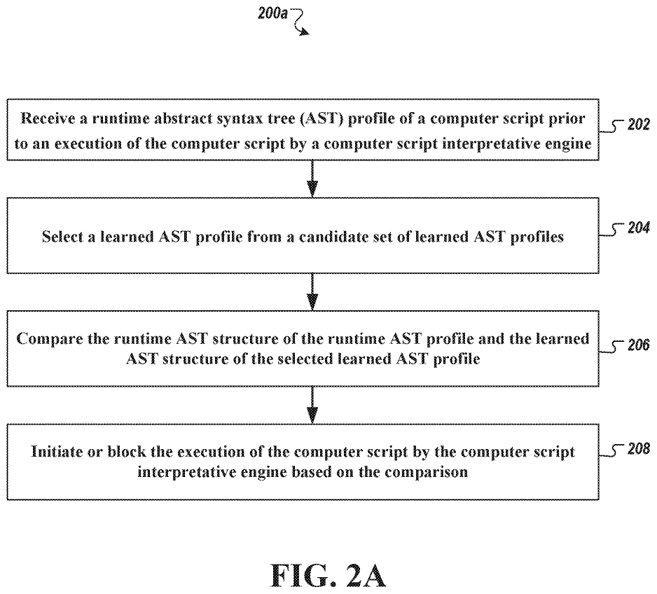

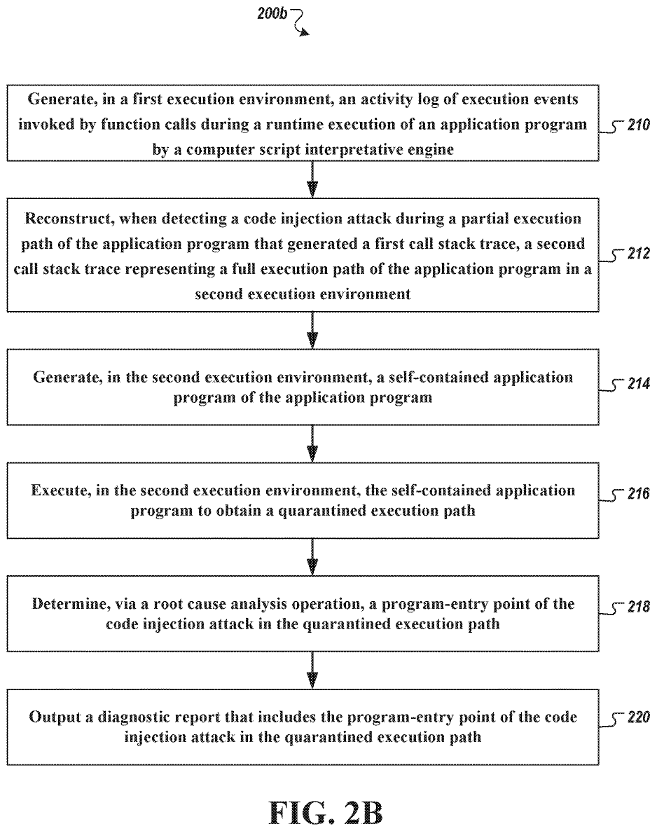

FIG. 2A shows an example method 200a for verifying a computer script or program (e.g., 114) prior to execution and blocking the computer script or program (e.g., 114) (e.g., application program) from being executed by a computer script interpretative engine (e.g., 102) (e.g., JavaScript interpreter) if the computer script or program (e.g., 114) is malicious (e.g., having an injection attack), in accordance with an illustrative embodiment.

In FIG. 2A, the method 200a includes receiving (202) a runtime abstract syntax tree (AST) profile (e.g., 116) of the computer script or program (e.g., 114) prior to the execution of the computer script or program (e.g., 114) by the interpretative engine (e.g., 102). The runtime AST profile (e.g., 116) can include a runtime AST structure associated with a set of runtime metadata (e.g., execution context values, e.g., URL, caller, etc.).

In some embodiments, the set of runtime metadata specifies at least (i) an execution environment (e.g., execution context) for the interpretative engine (e.g., 102) to execute the computer script or program (e.g., 114) therein, (ii) a process in which the interpretative engine (e.g., 102) loads the computer script or program (e.g., 114), or (iii) a combination thereof.

The method 200a then includes selecting (204) a learned AST profile (e.g., 122) from a candidate set of learned AST profiles (e.g., 120) by matching (i) one or more metadata in a set of learned metadata of the learned AST profile (e.g., 122) with (ii) respective one or more metadata in the set of runtime metadata of the runtime AST profile (e.g., 116). Each of the candidate set of learned AST profiles (e.g., 120) can include a learned AST structure associated with a set of learned metadata.

Each of the runtime AST structure (e.g., 116) and selected learned AST structure (e.g., 122) includes a set of nodes and a set of edges connecting the nodes. In some embodiments, the set of nodes includes (i) one or more executable-logic nodes, each representing an executable operation within the computer script or program (e.g., 114), and/or (ii) one or more data nodes, each representing a data value within the computer script or program (e.g., 114).

The method 200a then includes comparing (206) (i) the runtime AST structure of the runtime AST profile (e.g., 116) with (ii) the learned AST structure of the selected learned AST profile (e.g., 122). Specifically, the method 200a includes comparing (i) each executable-logic node of the runtime AST structure to a respective executable-logic node of the selected learned AST structure, and (ii) each data node of the runtime AST structure to a respective data node of the selected learned AST structure.

The method 200a then includes initiating or blocking (208) execution of the computer script or program (e.g., 114) by the interpretative engine (e.g., 102) based on the comparison 206. Specifically, the method 200a includes blocking the execution of the computer script or program (e.g., 114) by the interpretative engine (e.g., 102) if. (i) a data node in the runtime AST structure and a respective data node in the selected learned AST structure represent data values of different data types, (ii) an executable-logic node in the runtime AST structure and a respective executable-logic node in the selected learned AST structure represent different executable operations, or (iii) a data or executable-logic node in the runtime AST structure have a different number or arrangement of neighboring nodes (e.g., children nodes) from a respective data or executable-logic node in the selected learned AST structure.

At step 204, if no learned AST profiles are selected from the candidate set of learned AST profiles (e.g., 120), the method 200a includes (i) receiving a predefined set of security policies (e.g., 112) and (ii) initiating or blocking execution of the computer script or program (e.g., 114) by the interpretative engine (e.g., 102) based on the received predefined set of security policies (e.g., 112). Specifically, the method 200 includes blocking the execution of the computer script or program (e.g., 114), based on a zero-trust execution policy, an origin-based policy, or a data-flow-based policy.

In accordance with the zero-trust execution policy, the method 200a includes blocking the execution of the computer script or program (e.g., 114) when the execution environment can provide the interpretative engine (e.g., 102) with access to an operating system of a host device (e.g., computer) of the interpretative engine (e.g., 102).

In accordance with the origin-based policy, the method 200a includes blocking the execution of the computer script or program (e.g., 114) when an origin identifier associated with a runtime metadata of the runtime AST profile (e.g., 116) mismatches a predefined origin identifier.

In accordance with the data-flow-based policy, the method 200a includes blocking the execution of the computer script or program (e.g., 114) when one or more variables within the computer script or program (e.g., 114) utilize resources outside the computer script or program (e.g., 114).

In some embodiments, the candidate set of learned AST profiles (e.g., 120) was generated by parsing a set of computer scripts or programs without executing the set of computer scripts or programs.

In some embodiments, the candidate set of learned AST profiles (e.g., 120) was further generated using runtime AST profiles generated by executions of the set of computer scripts or programs.

FIG. 2B shows an example method 200b for identifying a point of injection (e.g., 182) of a code injection attack on a computer script or program execution (e.g., 128), in accordance with an illustrative embodiment.

In FIG. 2B, the method 200b includes generating (210), in a first execution environment (e.g., 154), an activity log (e.g., 174) of execution events invoked by function calls during the runtime execution of the computer script or program (e.g., 114). In some embodiments, the generated activity log (e.g., 174) captures, for each execution event, at least one of an event type, a payload identifier, a location in the computer script or program (e.g., 114) that invoked the event, an identifier of the first call stack trace, and an identifier of a callback function for the execution event.

When detecting (e.g., 160) a code injection attack (e.g., Synode) during a partial execution path of the computer script or program (e.g., 114), in which the partial execution path generated a first call stack trace (e.g., 172), the method 200b includes reconstructing (212), in a second execution environment (e.g., 156), a second call stack trace (e.g., 176) representing a full execution path of the computer script or program (e.g., 114). In some embodiments, the second call stack trace (e.g., 176) is reconstructed by correlating the generated activity log (e.g., 174) with the first call stack trace (e.g., 172) captured at a point of detection of the code injection attack.

The method 200b then includes generating (214), in the second execution environment (e.g., 156), a self-contained computer program (e.g., 178) (also referred to as a self-contained application program) based on the second call stack trace (e.g., 176). The method 200b then includes executing (216), in the second execution environment (e.g., 156), the self-contained computer program (e.g., 178) to obtain a quarantined execution path (e.g., 180). The method 200b then includes determining (218), via a root cause analysis operation (e.g., 170) (e.g., trace analysis operation), a program-entry point (e.g., 182) of the code injection attack in the quarantined execution path (e.g., 180). The method 200b then includes outputting (220) a diagnostic report (e.g., 152) (e.g., root cause report) that includes the program-entry point (e.g., 182) of the code injection attack in the quarantined execution path (e.g., 180).

During the reconstruction 212 of the second call stack trace (e.g., 176), the method 200b includes (i) identifying, based on the second call stack trace (e.g., 176), functions (e.g., JavaScript functions) associated with the self-contained computer program (e.g., 178), (ii) determining, based on the second call stack trace (e.g., 176), variables and function calls associated with each of the identified functions, (iii) generating a symbolic value (e.g., placeholder value) for every missing variable or function calls associated with each of the identified functions, and (iv) determining, based on the second call stack trace (e.g., 176), a logical execution flow between the identified functions. In some embodiments, the second call stack trace (e.g., 176) is configured to maintain a correspondence between every function associated with the executed computer program (e.g., 114) and a respective function associated with the self-contained computer program (e.g., 178).

At step 218, during the root cause analysis operation, the method 200b includes (i) identifying a value in the quarantined execution path (e.g., 180) that is derived from an execution event in the activity log (e.g., 174) and associated with the executed computer script or program (e.g., 114), (ii) traversing the quarantined execution path (e.g., 180) backward, starting from the point of detection (e.g., 160) of the code injection attack, to trace propagation of the identified value along the quarantined execution path (e.g., 180), and (iii) identifying, as the program-entry point (e.g., 182) of the code injection attack, a location in the quarantined execution path (e.g., 180) at which the identified value is first inserted into the quarantined execution path (e.g., 180).

At step 218, if the root cause analysis operation (e.g., 170) cannot identify the program-entry point (e.g., 182) of the code injection attack, the method 200b includes iteratively re-executing the self-contained computer program (e.g., 178) until the program-entry point (e.g., 182) of the code injection attack is determined.

In some embodiments, the method 200b further includes iteratively rewriting, via a trained AI model (e.g., 190), the self-contained computer program (e.g., 178) until no program-entry points (e.g., 182) of the code injection attack are determined.

### Example Artificial Intelligence (AI) or Machine Learning (ML) Models

Machine Learning. In the exemplary system 100 (e.g., 100d, 100e), the script/program rewriting AI or ML models (e.g., 190) can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include, but are not limited to, artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Example Implementation for Defense Against Code Injection

The exemplary system is configured to prevent code injection attacks for software, web, and computer applications. The exemplary system can (i) defend applications against remote attackers attempting to inject malicious payloads and (ii) safeguard users who copy and paste such payloads. The attacks exploit vulnerabilities in the applications and their dependencies, allowing remote attackers to control the victim's device or steal their digital assets. The exemplary system does not require the application code to be human-readable and can operate directly on production-build code as released, including code that is minified, bundled, or obfuscated.

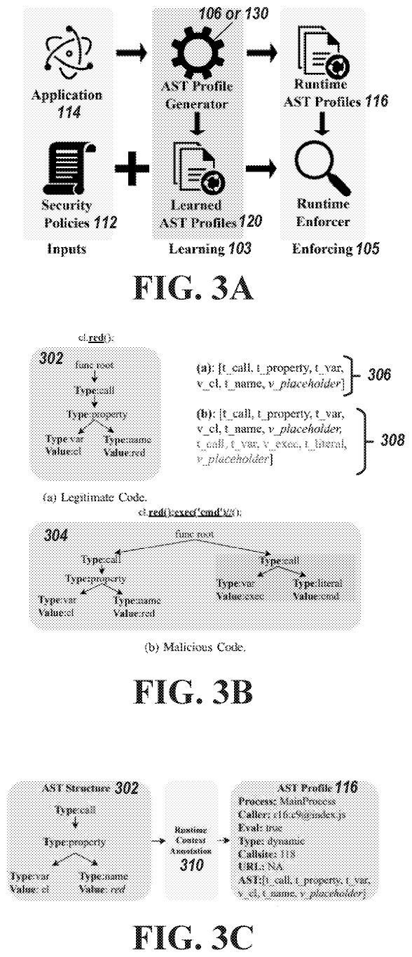

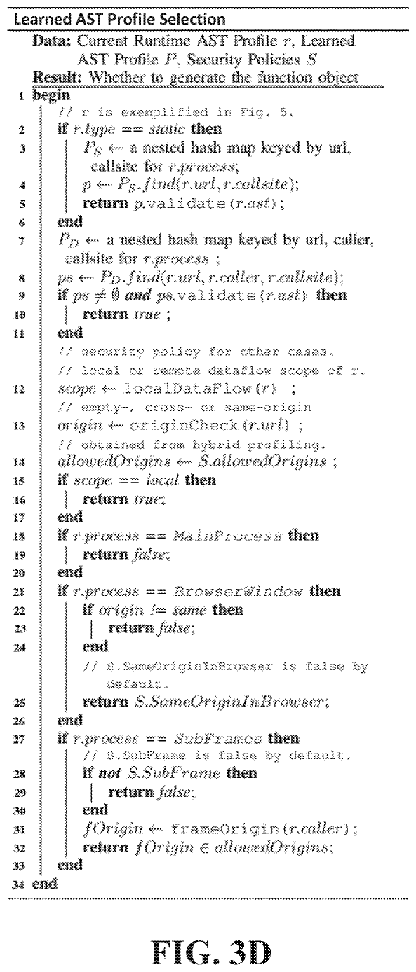

FIG. 3A shows an example operational flow of the exemplary system (e.g., 100) to defend an application 114 against code injection attacks, in accordance with an illustrative embodiment. As shown, the exemplar system can use an application (e.g., 132) (e.g., Electron application) during a learning phase 105 to construct its abstract syntax tree (AST) profiles 120 for enforcement. During an enforcing phase 103, the exemplary system can validate the runtime AST profiles 116 against the learned AST profiles 120. Unlearned AST profiles encountered at runtime can be handled in accordance with predefined security policies 112, depending on the protection mode: security-first or usability-first. The exemplary system can operate within a language interpreter (e.g., 102), where all JavaScript code (i.e., web and native) can pass through. This way, the exemplary system can provide comprehensive protection and tamper-proofing against remote attacks, since it can have higher privileges than the JavaScript code running in the interpreter (e.g., 102). The exemplary system can also leverage the current JavaScript code parsing process to construct AST profiles 116, incurring negligible runtime overhead. Table 1 summarizes the main characteristics of the exemplary system.

TABLE 1

| Characteristic | Details |
|---|---|
| Comprehensive | The exemplary system can address all code injection attacks, covering |
| protection | prevalent web attack vectors such as XSS, prototype pollution, and |
| | client-side redirects. The protection provided by the exemplary system |
| | can apply across all layers, including first-party code, third-party |
| | libraries, and remote code that applications may load. In addition to |
| | providing comprehensive protection, the exemplary system can also |
| | preserve the core functionality of the applications (e.g., 114). By |
| | implementing protection modes such as security-first for heightened |
| | protection and usability-first for greater functionality, the exemplary |
| | system can accommodate different user priorities, achieving a balance |
| | between security and usability. |
| Negligible | The exemplary system can operate with minimal runtime overhead, |
| runtime overhead | avoiding any lag that may lead users to disable the defense. |
| Tamper-proofing | To ensure robust security, the exemplary can be deployed within a |
| | privileged layer inaccessible to remote attackers, thereby preventing |
| | unauthorized modifications. |

Abstract Syntax Tree (AST) Profile. An AST profile should block maliciously injected code while allowing legitimate code. In code injection, an AST profile (e.g., 116) in the exemplary system is an abstract representation of the source code (e.g., of 114), whether it is legitimate static code or dynamically generated with legitimate inputs from remote sources (e.g., user inputs, network responses), given its execution context. The naive code-signing method can guarantee the legitimacy of static code, but cannot accommodate dynamically generated code whose signature can change. To evaluate the legitimacy of both static and dynamically generated code, the exemplary system can build AST profiles (e.g., 116) by generating context-aware AST structural signatures.

To generate AST structures (e.g., 302) for any code, whether hard-coded (static) or dynamically generated (dynamic), the exemplary system can extract each AST node's type, value, and position when the interpreter (e.g., 102) parses the source code. To accommodate varying legitimate user inputs in dynamic code, the exemplary system can replace concrete values with placeholders for specific data nodes. Table 2 lists all types of data nodes in an AST structure, including the value of a literal, name, or key node, which can be a string or a number. The value of a value node under a property parent can be an object literal, an array literal, a string, or a number. None of the nodes in the AST structure should introduce function definitions or invocations. If controlled by an attacker, a variable proxy (e.g., the variable's identifier) can be pointed to a function or an object. Therefore, the exemplary system can only change the value when the variable proxy node is not under a call, new, or assign expression.

TABLE 2

| Node type | Parent type | Data type |
|---|---|---|
| literal | any | string or number |
| name | property | string or number |
| key | property | string or number |
| value | property | object or array literal, |
| | | string, or number |
| variable proxy | not (call or | string |
| | assign or new) | |

FIG. 3B shows example AST structural signatures 306 and 308 of legitimate and malicious code, respectively. The AST structural signature 306 can prevent malicious inputs from defining new functions, overwriting prototype functions, calling existing functions, or executing code directly, which searching for function-related operations cannot achieve. For example, in FIG. 3B, given a JavaScript code, such as eval(‘cl.${color}( )’), that is vulnerable to code injection attacks, the dynamic input is color. An expected legitimate color can be literal (e.g., red). In FIG. 3B, subpanel (a), when eval executes, an AST structure 302 can be generated. However, in FIG. 3B, subpanel (b), attackers change the value of color from red( ) to red( ); exec(‘cmd’)//, resulting in arbitrary code execution and a different AST structure 304. In FIG. 3B, by checking the code's AST structural signature 308 in subpanel (b) with the baseline 306 in subpanel (a), the exemplary system detects and rejects the malicious code, exec(‘cmd’). Since the exemplary system does not consider a node's values for property.name, any legitimate, expected inputs to color (e.g., yellow, green) can pass the validation.

Detecting only function invocations in the AST structure 302 can be insufficient, as injected code can be executed without invoking existing functions. To address this, the AST structural signature 306 can capture both function-related operations and direct code execution paths, ensuring that even non-invoked, standalone code injections are detected and enhancing the protection's robustness by accounting for all possible injection vectors within the AST structure 302.

The execution context is important for applications to distinguish between the privileges of web and native code and to generate finer-grained AST profiles (e.g., 116) to mitigate mimicry attacks [29]. For example, if attackers can exploit an application's vulnerabilities (e.g., CVE-2022-29247 [30]) to access the native environment via the web layer, the attackers can import NodeJS libraries as defined in the native code to pass the AST structural signature validation.

FIG. 3C shows an example construction of an AST profile 116 by extracting the AST structural signature (e.g., 306) annotated with runtime context 310 (e.g., metadata) for the example in FIG. 3B. Based on the least-privilege principle, the exemplary system can isolate AST profiles 116 based on their running processes (e.g., MainProcess, BrowserWindow, SubFrames) and annotate each AST profile 116 with process context and code context, including the caller information and the callsite location if it is an eval-like call (see FIG. 3C). To facilitate fast enforcement, the exemplary system can also divide the AST profiles 116 into two categories, static and dynamic, per process.

Table 3 shows example configurations for a static AST profile and a dynamic AST profile.

TABLE 3

| AST | |
|---|---|
| profile type | Configuration |
| Static AST | The exemplary system can treat an AST profile as static when an interpreter |
| profile | (e.g., 102) interprets a static script file (e.g., 132) and its defined functions. |
| | For example, when a web application renders an HTML page, an HTML |
| | parser can invoke the V8 compiler to compile code defined in <script |
| | src = “A.js”>>. The requester is the HTML parser, so static profiles have |
| | no execution context other than the running process. Due to the lazy |
| | compilation policy [1], not all JavaScript code in a script file is immediately |
| | interpreted. Some functions, if not immediately invoked, can only be parsed |
| | and compiled when other code invokes them. Specifically, while parsing a |
| | script's source code, the parser may skip some functions not immediately |
| | invoked and remember their names and scopes. When those skipped |
| | functions are invoked, the parser can parse the function body to generate |
| | bytecode for them. At this time, the requester is a JavaScript function. |
| | However, these functions are defined in the static script file and are not |
| | changeable. Therefore, the exemplary system can still treat the AST profiles |
| | of such lazily compiled functions as static after checking their original |
| | scripts against local files. |
| Dynamic AST | The exemplary system can treat an AST profile as dynamic when the source |
| profile | code is generated by dynamic code-generation APIs (e.g., EventHandler, |
| | eval, document.write), as obtained from the code injection sinks defined in |
| | CodeQL [31]. Beyond the code-injection sinks, the exemplary system can |
| | also consider the scenario in which one script includes or imports another. |
| | For example, when script A includes script B by appending another |
| | <script> tag, or when script A uses eval-like or importScript APIs to |
| | dynamically execute code, the exemplary system can treat the AST profile |
| | of Script B, or the dynamically evaluated code, as a dynamic profile. |
| | Dynamically generated code can also comply with the lazy compilation |
| | policy. The exemplary system can use the same method to assign types to |
| | functions defined in dynamically generated code. |

In FIG. 3C, an eval-like API is invoked at the 118^{th} character of a caller function defined at row 16, column 9 in the file “index.js.” Since this code is dynamically generated, the profile type is “dynamic,” and the URL is marked as “N/A.” Because property.name is a data node, the value is marked as a placeholder.

LearnedASTProfile Collection. An application (e.g., web, software, or computer application) can be statically or dynamically modeled. However, the accuracy of static analysis can decrease for bundled, minified, or obfuscated JavaScript code, which is the format of applications for production release. Moreover, static analysis cannot provide an accurate execution context during enforcement (e.g., 103). For example, without running the code, the process in which the code will run cannot be known. Therefore, the exemplary system employs a hybrid learning method to build AST profiles (e.g., 120) of an application. Static profiling can ensure the completeness of the application, while dynamic profiling can complement the completeness by annotating contextual information and recording dynamic code execution at runtime.

The exemplary system can collect AST profiles (e.g., 120) at the function level to preserve AST structural integrity within the execution context. This aligns with the interpreter's compilation process, in which functions serve as the fundamental units of execution. The exemplary system also enforces policies by causing the interpreter (e.g., 102) (e.g., JavaScript interpreter) to return a no-operation function when an AST profile (e.g., 116) is invalid and, otherwise, to return the original function object. With this function-level granularity, the exemplary system can learn static AST profiles (e.g., 120) (denoted as P_{S}) through static profiling (denoted as S) and dynamic AST profiles (e.g., 116) (denoted as P_{D}) through dynamic profiling (denoted as D) for an application (denoted as A), which together can be denoted as P_{A}=P_{S}∪P_{D}.

Table 4 shows an example static profiling method and dynamic profiling method that the exemplary system employs to build a learned AST profile collection (e.g. 120).

TABLE 4

| AST | |
|---|---|
| profiling method | Description |
| Static AST | The exemplary system can customize D8 [2], a shell interface to V8 |
| profiling | (a compiler), to invoke V8's parser and generate AST structural |
| | signatures, thereby disabling lazy compilation and causing the parser |
| | to build the AST structural signature for every JavaScript function |
| | defined in local files. This can enable static profiling to provide the |
| | exemplary system with a comprehensive model of the application. |
| | Specifically, the exemplary system can obtain a static AST profile |
| | (Ps) defined per Equation 1. |
| | Ps = {p_{i, j} = G(i, j) \| ∀Fᵢ ∈ A, ∀fⱼ ∈ Fᵢ} |
| | (Eq. 1) |
| | In Equation 1, Ps is the set of all AST structural signatures collected |
| | from every JavaScript function in every file of A, G is the AST |
| | structural signature generation procedure, Fᵢ is a JavaScript file |
| | contained in A's installation package, fⱼ is a JavaScript function |
| | defined in Fᵢ, i is the URL (e.g., file://path) of a JavaScript file, and j |
| | is the location (e.g., row and column) of a JavaScript function. |
| | During dynamic profiling, p_{i, j} is annotated with the runtime context |
| | based on i. In some embodiments, Ps is a complete set of all |
| | JavaScript functions in A. |
| Dynamic AST | The exemplary system can exercise each application to supplement |
| profiling | the static profiles (Ps) using a method that simulates user |
| | interactions (similar to [20], [32], [33]). The simulation method can |
| | employ a crawler that interacts with the application's user interface |
| | (UI) (e.g., clicking on buttons and menus and typing text). To cover |
| | the application's complex features, the simulation method can be |
| | supplemented with manual exercises based on the application's user |
| | manuals. If available, end-to-end test cases can be used to simulate |
| | user interactions and trigger features, ensuring that all application |
| | functionalities are covered. Given a dynamic code trigger action |
| | (denoted as T) in dynamic profiling, the exemplary system can |
| | obtain a dynamic AST profile defined per Equation 2. |
| | P_{D} = {p_{i, j} = G(i, j) \| Cⱼ ∈ Fᵢ, Fᵢ ∈ A, T(i, j) is triggered} |
| | (Eq. 2) |
| | In Equation 2, G denotes AST structural signature generation, and Cⱼ |
| | denotes dynamic code-execution APIs within JavaScript file Fᵢ, |
| | discovered during static profiling. |

Runtime Enforcement. In the enforcing phase (e.g., 103), the exemplary system can validate runtime AST profiles (e.g., 116) (defined as R=R_{D}+R_{S}, where R_{D} and R_{S} denote dynamic and static AST profiles generated at runtime, respectively) against those (e.g., 120) learned in the learning phase (defined as P=P_{D}+P_{S}). Any unlearned profiles (defined as U=R−P) can be handled in accordance with predefined security policies (e.g., 112). Since P_{S} is a complete set of JavaScript functions in A, R_{S}−P_{S}=Ø, concluding U=R_{D}−P_{D}. The unlearned profile set U can include true positives due to attacks (denoted as T) and false positives due to unlearned application features (denoted as F). During enforcement (e.g., 103), the exemplary system can block T and accommodate F with best-effort security-first security policies.

FIG. 3D shows an example algorithmic implementation for the exemplary system to select/enforce a learned AST profile (e.g., 122) during enforcement (e.g., 103), in accordance with an illustrative embodiment. In FIG. 3D, the exemplary system receives a runtime AST profile (e.g., 116) (denoted as r) and learned AST profiles (e.g., 120) (denoted as P). If r is a static profile, the exemplary system checks r against P_{S} using its URL and callsite (see FIG. 3D, lines 2-6). When r is a dynamic profile, the exemplary system tries to find a match in P_{D} based on its URL, caller, and callsite. If the exemplary system can find the learned AST profiles (e.g., 122) for the given execution context, the exemplary system lets r proceed as long as R.ast is validated (see FIG. 3D, lines 7-11). Otherwise, the exemplary system applies the predefined security policies (e.g., 112) on r to determine its security impact and proceed accordingly (see FIG. 3D, lines 12-33).

Security Policies for Unlearned AST Profiles. In some embodiments, the security policies (e.g., 112) for the exemplary system are configured, based on existing security models, to assess the data flow for imported dynamic code, the execution context in which the imported code is intended to run, and the security origins of remote resources. The exemplary system can employ two working modes, e.g., security-first and usability-first, to balance security and usability.

First, the exemplary system performs a data flow analysis on r along its call stack trace to determine whether its source code contains only locally defined variables. For example, a network response is considered a remote variable, as it is not defined within the local scope, whereas a hard-coded string is locally defined. Based on the data flow analysis, the exemplary system assigns r a scope designation of local or remote (see FIG. 3D, line 12). If r has a local scope, e.g., the source code is concatenated with hard-coded strings, the exemplary system permits r to proceed regardless of the running process (see FIG. 3D, lines 15-17).

Next, the exemplary system checks the security origin of r and assigns it one of three values: same, cross, or empty (see FIG. 3D, line 13), where empty indicates that the dynamic code is generated by eval or Function. Simultaneously, the exemplary system loads allowed security origins as defined in the application, obtained through the hybrid profiling process (see FIG. 3D, line 14). The exemplary system then examines the process in which r is intended to run to determine its privilege level. If r is in the MainProcess process, the exemplary system rejects r based on a zero-trust security policy (see FIG. 3D, lines 18-20). If r is in the BrowserWindow process and its security origin differs from that of BrowserWindow, the exemplary system also rejects r. If the security origin matches, the exemplary system consults a user-defined property (e.g., SameOriginInBrowser) to decide whether to permit same-origin content in BrowserWindow, defaulting to false (see FIG. 3D, lines 21-26). For SubFrames, the exemplary system denies r if the user has disabled SubFrames, which is disabled by default. Otherwise, the exemplary system allows r only if its security origin matches one of the allowed security origins (see FIG. 3D, lines 27-33).

Security Analysis (ASTProfile Comparison). Table 5 presents the definitions of the variables or structures used in the AST profile comparison (e.g., 110).

TABLE 5

| Variable/Structure | Definition |
|---|---|
| T_{model} | T_{model} is an AST representation of the program execution learned in the |
| | profiling phase (e.g., 105) of the exemplary system. |
| Tᵣᵤₙₜᵢₘₑ | Tᵣᵤₙₜᵢₘₑ is an AST resulting from runtime input (e.g., user input, dynamic |
| | code) in the enforcing phase (e.g., 103) of the exemplary system. |
| V | V is the set of T_{model} learned from the whole program, and T_{model} ∈ V. |
| C | C is the execution context of a T_{model} at a given program point, and T_{model} ∈ |
| | V_{C}, V_{C} ⊆ V. |
| DataNode ⊂ T | DataNode is the set of leaf nodes (referred to as data nodes) representing |
| | data values (e.g., string literals) expected to vary at runtime. |
| ExecNode ⊂ T | ExecNode is the set of internal nodes (referred to as executable/exec |
| | nodes) representing executable logic (e.g., a call expression). |
| Intermediate | IntermediateNode is the set of internal nodes representing expressions and |
| Node ⊂ T | statements (e.g., block statement). |
| Children(n) | Each node n ∈ IntermediateNode has a sequence of children forming a |
| | subtree, denoted by Children(n) = [n₁, n₂, . . . , nₖ]. |

During the AST comparison (e.g., 110), the exemplary system can enforce the AST structural signature (e.g., 306) by Equation 3.

$$Match ( {T}_{model} , {T}_{runTime} ) = {∧}_{i = 1}^{k} match ( {m}_{i} , {r}_{i} ) \qquad ( Eq . 3 )$$

In Equation 3, the exemplary system requires that ∀mᵢ∈T_{model}, rᵢ∈Tᵣᵤₙₜᵢₘₑ, and match(mᵢ, rᵢ)=true. The type of a node n∈T, denoted as type(n), can be defined per Equation 4.

$$type ( n ) = \{ \begin{matrix}data if n ϵ DataNodes \\ exec if n ϵ ExecNodes \\ intermediate otherwise\end{matrix} \qquad ( Eq . 4 )$$

The value of the match(mᵢ, rᵢ) function, given ∀mᵢ∈T_{model} and rᵢ∈Tᵣᵤₙₜᵢₘₑ, can be defined according to the conditions #1-#3 shown in Table 6.

TABLE 6

| Condition | Detail | |
|---|---|---|
| 1) Type mismatch is disallowed. | type(mᵢ) ≠ type(rᵢ) ⇒ match(mᵢ, rᵢ) = false | (Eq. 5) |

| | |
|---|---|
| 2) Data nodes should match in type. | $\{ \begin{matrix}type ( {m}_{i} ) = data \\ type ( {r}_{i} ) = data\end{matrix} ⇒ match ( {m}_{i} , {r}_{i} ) = true \qquad ( Eq . 6 )$ |
| 3) Exec nodes should exactly match. | $\{ \begin{matrix}type ( {m}_{i} ) = exec \\ type ( {r}_{i} ) = exec\end{matrix} ⇒ match ( {m}_{i} , {r}_{i} ) = ( {m}_{i} == {r}_{i} ) \qquad ( Eq . 7 )$ |
| 4) Intermediate nodes should recursively match on their children | $\{ \begin{matrix}type ( {m}_{i} ) = intermediate \\ children ( {m}_{i} ) = [ {m}_{{i}_{1}} , {m}_{{i}_{2}} , … , {m}_{{i}_{k}} ] \\ type ( {r}_{i} ) = intermediate \\ children ( {r}_{i} ) = [ {r}_{{i}_{1}} , {r}_{{i}_{2}} , … , {r}_{{i}_{k}} ]\end{matrix}$ |
| | $⇒ match ( {m}_{i} , {r}_{i} ) = {∧}_{j = 1}^{k} match ( {m}_{{i}_{j}} , {r}_{{i}_{j}} ) \qquad ( Eq . 8 )$ |

The exemplary system can enforce that any runtime AST structure (e.g., 302) should conform to the allowed structure for its execution context, as shown in Equation 9, such that Match(Tmodel, Tᵣᵤₙₜᵢₘₑ)=true at context C.

∀Tᵣᵤₙₜᵢₘₑ,∃T_{model}∈V_{C} (Eq. 9)

Consider a code-injection gadget in the document object model (DOM) of an application: element.appendChild(user inputs). Let U denote the user inputs. If the exemplary system observes only non-script DOM nodes from U during the learning phase (e.g., 105), the exemplary system can obtain V_{C}=Ø, where C is the execution context of this API call. Then, the exemplary system can block any injected scripts since ¬(∃U_{model}∈V_{C}). If U contains script elements in the learning phase (e.g., 105), then U_{model}∈V_{C}. The exemplary system can then permit, during enforcement (e.g., 103), only structurally consistent ASTs with variability restricted to data leaf nodes, as shown in Equation 10.

∃U_{model}∈V_{C}∧Match(U_{model},Uᵣᵤₙₜᵢₘₑ) (Eq. 10)

Thus, the attacker's freedom is limited to modifying literal values (e.g., strings, constants), but not to define, modify, or invoke arbitrary logic. Any injected payload that deviates from the learned script structure can be blocked under the condition described by Equation 11.

Match(U_{model},Uᵣᵤₙₜᵢₘₑ)=false at context C (Eq. 11)

For cases where input validation cannot be resolved due to incomplete learning, ambiguous context, or mixed data types, the exemplary system can defer to a predefined set of security policies (see FIG. 3D). The security policies (e.g., 112) can combine static and dynamic analyses, such as local data flow inspection and runtime execution context profiling, to maintain security guarantees while supporting usability.

### Example Implementation for Diagnosis of Code Injection

In some embodiments, the exemplary system is configured to address, via a diagnosis module (e.g., 150), code injection attacks in applications or programs (e.g., JavaScript applications) by tracking event registrations and executions to reconstruct an equivalent, but simpler, vulnerable symbolic state of the original application or program.

The exemplary system, with the diagnosis module (e.g., 150), can include four operations during code injection attack diagnosis: event activity tracking (e.g., 158), program reconstruction (e.g., 166) (also referred to as program recomposition), symbolic analysis and execution (e.g., 168), and root cause report generation (e.g., 162, 170). During event activity tracking (e.g., 158), the exemplary system, via the diagnosis module (e.g., 150), can monitor and record event registration, triggering, and handling to recover the full call stack trace (e.g., 176). During program reconstruction (e.g., 166), the exemplary system, via the diagnosis module (e.g., 150), can construct a simplified program (e.g., 178) containing only the functions involved in the recovered trace (e.g., 176), mitigating state explosion for symbolic analysis. During iterative symbolic analysis, the exemplary system, via the diagnosis module (e.g., 150), can perform dynamic taint data-flow analysis using iterative symbolic execution to reconstruct the vulnerable symbolic state. During root cause report generation (e.g., 162, 170), the exemplary system, via the diagnosis module (e.g., 150), can analyze the execution traces to determine the root cause and pinpoint the injection location (e.g., 182).

Determining the injection point (e.g., 182) of a code injection attack can require reconstructing the vulnerable execution trace, which poses various challenges, as shown in Table 7, for applications (e.g., JavaScript applications) due to their dynamic nature.

TABLE 7

| Challenge | Detail |
|---|---|
| Challenge 1 (C1): | JavaScript applications do not provide built-in mechanisms to |
| Lack of event | construct a call stack trace for event activities. This lack of support |
| tracking support | can also extend to web applications for client-side redirect attacks |
| | (e.g., a malicious script navigates the user to an attacker-controlled |
| | website) and Node.js apps that leverage node:events. |
| Challenge 2 (C2): | Executed source code (of an application) can be dynamically |
| Dynamic code | generated. During a symbolic state reconstruction (e.g., vulnerable |
| generation | execution trace reconstruction), the source code may not know |
| | where or what to invoke in its caller function, leading to an |
| | incompletely recomposed, simplified program. This challenge |
| | applies to all JavaScript apps, as root cause analysis (RCA) aims to |
| | identify the injection point. |
| Challenge 3 (C3): | JavaScript production releases can bundle multiple packages with |
| Root cause location | minified or obfuscated code, which can complicate isolating and |
| | identifying the root cause of vulnerabilities. |

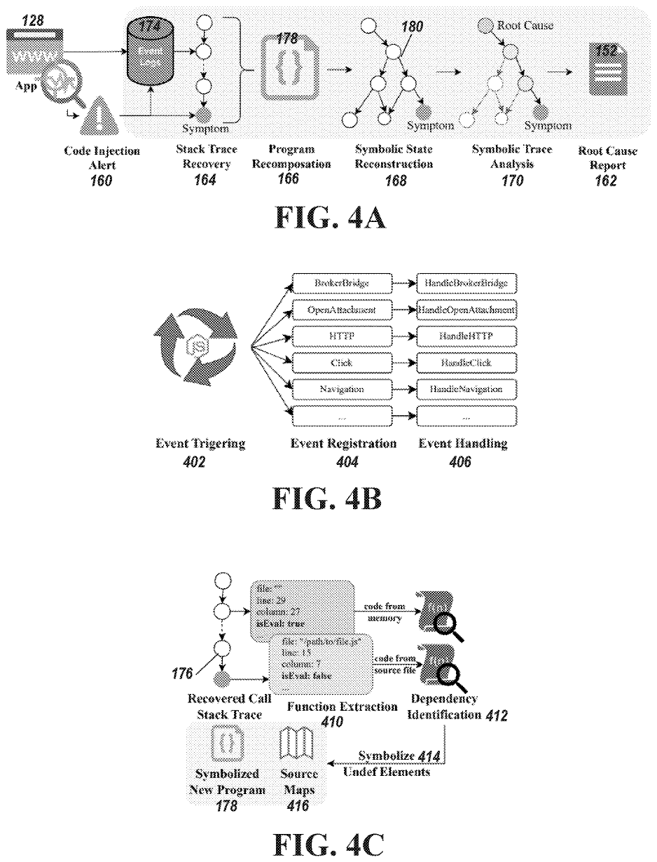

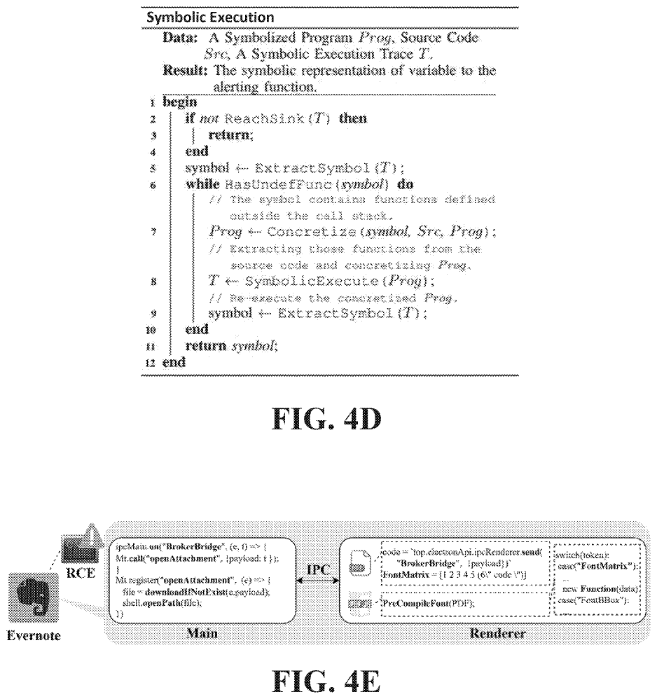

FIG. 4A shows an example operational flow of the exemplary system to determine, via the diagnosis module (e.g., 150), an injection point (e.g., 182) of a code injection attack, in accordance with an illustrative embodiment. As shown, an application (e.g., Web, Node.js, Electron, etc.) executes (128) with the event-tracking operation (e.g., 158) of the diagnosis module (e.g., 150), which monitors event activities. Event activities can be captured in event logs 174, which can facilitate the reconstruction 164 of a complete call stack trace (e.g., 176) to address the challenge C1.

When a code injection alert 160 is triggered, the exemplary system can initiate a diagnosis. First, the exemplary system can obtain, via the diagnosis module (e.g., 150), a call stack trace (e.g., 172) originating from the detected code injection symptom. The exemplary system, via the diagnosis module (e.g., 150), can then identify the top caller and determine whether the top caller corresponds to an event handler. Next, if the top caller is an event handler, the exemplary system can, via the diagnosis module (e.g., 150), iteratively search the event logs 174 for the function that triggered the event to recover the complete call stack trace (e.g., 176).

When the call stack trace (e.g., 176) is reconstructed, the exemplary system can, via the diagnosis module (e.g., 150), extract all relevant functions from the source code of the application (e.g., 114). If a function is dynamically generated (e.g., eval), the exemplary system can, via the diagnosis module (e.g., 150), retrieve the function's source code from the call stack frame when available, addressing the challenge C2. The extracted functions can then be linked together, with closure variables and functions marked as symbolic variables.

The recomposed, simplified program 178 can then be fed into a symbolic execution engine 168 to conduct dynamic taint analysis to track data flow, which can iteratively generate symbolic execution traces 180. The exemplary system, via the diagnosis module (e.g., 150), can analyze (170) the symbolic execution traces 180 to determine whether they lead to the code injection symptom and, if so, whether they indicate a vulnerability. Finally, the exemplary system, via the diagnosis module (e.g., 150), can produce (162) a root cause report 152 that includes a reconstructed execution trace 180 at the branch level and the branch that initiated the code injection attack, thereby identifying the root cause location (e.g., 182).

Stack Trace Recovery. A challenge in analyzing code injection attacks is reconstructing the execution context that leads to the vulnerability. Current debugging tools provide stack traces (e.g., 172) at runtime, but they fail to capture the complete execution history in event-driven application environments. This limitation arises because applications (e.g., 114), particularly in Web, Node.js, and Electron environments, rely on asynchronous event handling, which fragments execution contexts across multiple callbacks. Given these challenges, the exemplary system, via the diagnosis module (e.g., 150), can track event registration, triggering, and handling, allowing for the reconstruction of execution history beyond what standard stack traces provide.

FIG. 4B shows an example event activity tracking for stack trace recovery (e.g., 164) in the diagnosis module (e.g., 150), in accordance with an illustrative embodiment. Table 8 shows example operations for the event activity tracking in the diagnosis module (e.g., 150).

TABLE 8

| Operation | Description |
|---|---|
| Event registration | When a function (e.g., JavaScript) registers an event handler (e.g., via |
| tracking 404 | Target.addEventListener( ) on DOM objects or EventEmitter.on( ) for |
| | Node.js environment), the exemplary system, via the diagnosis module |
| | (e.g., 150), can record the event type, associated callback, registration |
| | location in the source code, and the call stack trace. |
| Event triggering | When an event is triggered (e.g., via user interaction or code from |
| tracking 402 | Target.dispatchEvent( )), the exemplary system, via the diagnosis module |
| | (e.g., 150), can log the event type, payload, and the current call stack trace. |
| Event handling | When an event handler executes, the exemplary system, via the diagnosis |
| tracking 406 | module (e.g., 150), can capture the event's context, including the event |
| | type and the stack frame at the point of execution. |
| Call stack | Upon detecting a code injection symptom, the exemplary system, via the |
| reconstruction 164 | diagnosis module (e.g., 150), can trace back the execution path by |
| | matching handled events to their activity logs (e.g., 174), recovering the |
| | full call stack trace (e.g., 176). |

Applications (e.g., 114) (e.g., JavaScript) can frequently generate code dynamically (e.g., using eval-like APIs). To facilitate completeness, the exemplary system, via the diagnosis module (e.g., 150), can extract dynamically generated functions from stack frames at execution time. Then, the exemplary system, via the diagnosis module (e.g., 150), can map these functions to their originating contexts when possible. Finally, the exemplary system, via the diagnosis module (e.g., 150), can incorporate dynamically created closures and bound variables in the reconstructed execution flow.

Simplified Program Reconstruction. When the full stack trace (e.g., 176) is recovered, the next challenge is preparing the execution context for symbolic analysis. Analyzing the entire application (e.g., 114) is infeasible due to state explosion and complexity. Instead, the exemplary system, via the diagnosis module (e.g., 150), can develop a simplified, self-contained program (e.g., 178) based on the recovered stack trace (e.g., 176). The simplified, self-contained program (e.g., 178) can retain all essential execution semantics from the original program (e.g., 114) while remaining tractable for analysis.

In the program reconstruction (e.g., 166), the vulnerable state/trace can be determined by a small subset of the program rather than the entire codebase. By isolating only the functions involved in the recovered call stack (e.g., 176), the exemplary system, via the diagnosis module (e.g., 150), can eliminate irrelevant code while preserving the necessary execution semantics. Any missing dependencies, such as external functions or variables, can be replaced with symbolic values, allowing the diagnosis module (e.g., 150) to generalize execution traces and explore additional attack paths. This approach can ensure that the simplified program (e.g., 178) remains lightweight, scalable, and expressive enough to reproduce and extend the original execution trace (e.g., 172).

FIG. 4C shows an example operational flow for generating a simplified, self-contained program 178 in the diagnosis module (e.g., 150), in accordance with an illustrative embodiment. In FIG. 4C, the exemplary system, via the diagnosis module (e.g., 150), extracts (410) all functions from the recovered stack trace 176 in the source code for statically defined functions, and from the dumped source code for dynamically generated functions. The extracted functions can constitute the core execution context. The exemplary system, via the diagnosis module (e.g., 150), then analyzes (412) function dependencies, identifying required variables, closures, and external function calls, using static analysis (e.g., JavaScript linter). Any function, variable, or external API that is not recovered is then replaced (414) with a symbolic value, allowing symbolic execution to explore multiple execution paths without being constrained by missing dependencies. The exemplary system, via the diagnosis module (e.g., 150), then connects the extracted functions according to their invocation relationships, ensuring that the simplified program 178 retains the logical execution flow.

Since the call stack trace 176 can include the location of each function, the exemplary system, via the diagnosis module (e.g., 150), can map the extracted functions with their original source. In some embodiments, the diagnosis module (e.g., 150) maintains three hash maps 416: one for locations in the source code with their function codes, one for locations in the new program with their function codes, and one for locations in the simplified program 178 with their corresponding locations in the source code.

By incorporating symbolic values for missing dependencies, the simplified, self-contained program 178 can generate execution traces (e.g., 180) that are a superset of the original execution trace (e.g., 172), since branches within functions are possible. In the vulnerable path, branches can be taken based on concrete inputs. To this end, the original vulnerable trace (e.g., 172) can be preserved.

Symbolic Analysis and Execution. After program reconstruction (e.g., 166), the exemplary system, via the diagnosis module (e.g., 150), is configured to perform dynamic taint analysis on the simplified program (e.g., 178). A symbolic execution engine (e.g., 168) can be used to facilitate the dynamic taint analysis, as the simplified program (e.g., 178) can contain undefined functions and/or variables (e.g., closures). Directly executing the program can lead to a crash. Using a symbolic execution engine (e.g., 168), on the other hand, can handle the undefined closures, preventing the execution from crashing. Since applications (e.g., 114) (e.g., JavaScript) can vary in execution environments and runtime semantics, the diagnosis module (e.g., 150) is configured to support both web and Node.js (e.g., via the Electron runtime) for symbolic execution (e.g., 168), facilitating precise tracking of symbolic values while preserving JavaScript's dynamic execution model.

The exemplary system, via the diagnosis module (e.g., 150), can reproduce the vulnerable execution state by running the program in a real-world JavaScript environment. To achieve this purpose, the exemplary system, via the diagnosis module (e.g., 150), can perform symbolic execution on the simplified program (e.g., 178). However, a single pass of symbolic execution may not fully resolve the data flow, especially when functions or variables were initially symbolized due to missing definitions. Instead of assuming all symbolic values are attacker-controlled, the exemplary system, via the diagnosis module (e.g., 150), can reevaluate the execution traces by iteratively concretizing and propagating symbolic constraints to distinguish between attacker-controlled data flows and benign symbolic values (e.g., functions outside the call stack trace).

FIG. 4D shows an example algorithmic implementation for the diagnosis module (e.g., 150) to execute the simplified, self-contained program (e.g., 178) to obtain symbolic execution traces (e.g., 180), in accordance with an illustrative embodiment. In FIG. 4D, the exemplary system, via the diagnosis module (e.g., 150), can first automatically create a harness to invoke the simplified, self-contained program (e.g., 178) by marking the input arguments as symbols. The exemplary system, via the diagnosis module (e.g., 150), can then create symbolic procedures for undefined functions within the simplified program (e.g., 178). The symbolic execution engine (e.g., 168) can then explore all feasible execution paths while tracking constraints on symbolic values. Finally, after exploring all paths, the exemplary system, via the diagnosis module (e.g., 150), can extract the execution traces that reach the symptom function (e.g., the alerting function).

After obtaining the symbolic execution traces (e.g., 180), the exemplary system, via the diagnosis module (e.g., 150), can determine whether the injected code contains attacker-controlled variables. Conventional taint analysis can rely on predefined sources (e.g., network responses, user input) to infer attacker control. However, because the recomposed simplified program (e.g., 178) can contain symbolized undefined functions and variables, the conventional taint analysis can yield incomplete or incorrect results. To address this, the diagnosis module (e.g., 150) employs iterative symbolic analysis to refine the data flow to validate whether an alerting function receives attacker-controlled input.

Given a symbolized program (e.g., 178) (denoted as Prog), the source code (denoted as src), and a symbolic execution trace (e.g., 180) (denoted as T), the iterative symbolic analysis can start by checking whether the trace reaches the alerting function. If so, the iterative symbolic analysis can proceed to determine whether the final symbol flows to the function containing the undefined functions. The undefined functions can be symbolic functions defined in the simplified program (e.g., 180). If the symbol has them, the exemplary system, via the diagnosis module (e.g., 150), can retrieve the function definitions from the source code and concretize the program Prog. Specifically, the diagnosis module (e.g., 150) can replace the symbolic procedures with concrete function definitions. The concrete function can also invoke functions not defined locally (e.g., closure functions). In this case, the diagnosis module (e.g., 150) can mark those closure functions as symbolic procedures again, before executing the concreted Prog again until the final symbol does not contain any undefined functions. Finally, the iteration process returns a symbol containing only symbolic variables and their constraints.

Root Cause Analysis. The exemplary system, via the diagnosis module (e.g., 150), can then analyze the symbolic execution trace (e.g., 180) to pinpoint the injection point and identify the attack vector that enabled the vulnerability. Given a symbolic execution trace (e.g., 180) reaching an alerting function, the diagnosis module (e.g., 150) is configured to determine (i) where in the execution flow the injection occurred and (ii) which data flow paths allowed attacker-controlled input to reach the injection sink. This process can facilitate precise vulnerability attribution and automated patch recommendations.

The injection point and attack vector can be traced by examining the data flow within the symbolic execution trace. Instead of only identifying the final function that executes malicious code, the exemplary system, via the diagnosis module (e.g., 150), can trace the symbolic constraints back to determine how attacker-controlled input propagated through the execution path, ensuring that the root cause analysis (e.g., 170) can capture both the immediate injection point and the underlying weakness that enabled the exploit.

The injection point (e.g., 182) can occur in the earliest program location where an attacker-controlled value can enter the execution flow and propagate to an injection sink. To locate this point, the exemplary system, via the diagnosis module (e.g., 150), can first perform backward symbolic trace analysis, tracing execution paths backward from the alerting function to determine where the injected data originated. Next, dependency tracking is used to analyze variable assignments, function arguments, and return values, ensuring that all symbolic values contributing to the injection sink are identified. To confirm attacker influence, the exemplary system, via the diagnosis module (e.g., 150), can perform taint verification, checking whether the tracked symbolic values originate from sources such as network responses, user inputs, or other external influences. Finally, once the earliest program location introducing attacker-controlled data is identified, the exemplary system, via the diagnosis module (e.g., 150), can classify it as the injection point (e.g., 182) and associate it with the relevant control flow path.

To determine the attack vector, the exemplary system, via the diagnosis module (e.g., 150), can analyze how the injected data traversed the program and reached the injection point (e.g., 182). The first step in this process is control flow path analysis, in which the diagnosis module (e.g., 150) reconstructs the sequence of function calls, event handlers, and callback chains that enabled data propagation. Next, the exemplary system, via the diagnosis module (e.g., 150), can perform symbolic constraint analysis to examine transformations applied to the injected data, such as string concatenation, sanitization attempts, or encoding operations. If modifications exist, the diagnosis module (e.g., 150) can determine whether these transformations still permit an attack. The diagnosis module (e.g., 150) can classify the vulnerability into one of three categories: direct injection, context-sensitive injection, and indirect injection. In direct injection, the attacker-controlled input reaches the sink without modification. In context-sensitive injection, the input undergoes transformations but remains injectable due to improper sanitization. In indirect injection, the attack occurs through an intermediate function call or event-driven execution.

Diagnostic Report Generation. After identifying the injection point and attack vector, the exemplary system, via the diagnosis module (e.g., 150), can generate a root cause report (e.g., 152) to assist users in vulnerability remediation. The report (e.g., 152) can include the reconstructed execution trace (e.g., 180), which highlights the key program branches leading to injection, helping users understand how the attack unfolded. Additionally, the report (e.g., 152) can specify the injection point (e.g., 182), providing the exact source code location where attacker-controlled data first entered the execution flow. To further clarify the attack mechanism, the exemplary system, via the diagnosis module (e.g., 150), can detail the attack vector and explain how the injected data propagated through the program. Finally, the report (e.g., 152) can provide suggested patch recommendations, including mitigation strategies such as input sanitization, secure API replacements, and event handler restrictions, using large language models (LLMs).

### Example Code Injection Attack Diagnosis

FIG. 4E shows an example diagnosis, by the diagnosis module (e.g., 150) of the exemplary system, of a code injection vulnerability CVE-2024-4367 [19′] affecting Evernote, an Electron-based application with over 200 million active users. CVE-2024-4367 stems from PDF.js [23′], a library maintained by Mozilla for rendering PDFs in browsers and desktop applications. Attackers exploit this code injection vulnerability by embedding malicious JavaScript payloads within the FontMatrix metadata of a PDF document, which, when processed, results in arbitrary code execution.

In FIG. 4E, the malicious payload is extracted and executed via new Function( ), leading to RCE. This event is then flagged by a runtime monitoring system (e.g., 160) due to the abnormal execution of shell commands within the renderer process. However, the monitoring system only captures the attack symptom, e.g., the execution of a system command, but does not reveal how the injected payload was processed or executed. After the monitoring system (e.g., 160) detects the anomalous behavior, the exemplary system, via the diagnosis module (e.g., 150), begins the diagnosis.

At the moment of attack execution, the diagnosis module (e.g., 150) collects the stack trace (e.g., 172) leading to the execution of the shell command. Initially, the stack trace (e.g., 172) contains only the immediate call sequence, capturing functions within the callback function that invoked the dangerous API. However, because Electron applications use event-driven execution and inter-process communication (IPC), the source of the vulnerability is not apparent. To reconstruct the full execution flow (e.g., 176), the diagnosis module (e.g., 150) bridges event listeners and emitters to link related execution paths. The event logs (e.g., 174) reveal that the vulnerable function was invoked via Electron's IPC mechanism, which is used for communication between the main and renderer processes. The diagnosis module (e.g., 150) traces this execution path across processes and identifies that the attack originated from a function within PreCompileFonto in PDF.js.

After reconstructing the call sequence, the diagnosis module (e.g., 150) extracts all relevant JavaScript functions involved in the execution flow. The recovered functions include PreCompileFonto, which processes the FontMatrix metadata from the PDF, and openAttachmento, which spawns the shell command. Because some dependencies are dynamically loaded at runtime, the diagnosis module (e.g., 150) symbolically represents undefined variables and missing functions to generalize execution traces (e.g., 176). By composing a simplified program (e.g., 178) that retains only the relevant execution logic, the diagnosis module (e.g., 150) ensures that symbolic execution remains tractable while preserving the key vulnerability conditions.

Using the recomposed program (e.g., 178), the diagnosis module (e.g., 150) performs iterative symbolic analysis to determine whether the injection point is attacker-controlled. The symbolic execution engine (e.g., 168) marks file path arguments and metadata fields as symbolic variables and explores execution traces where these values propagate to dangerous functions. Through iterative refinement, the diagnosis module (e.g., 150) reveals that the injected FontMatrix value undergoes string manipulation and then reaches new Function( ) to be executed as JavaScript. This indicates that the attacker controls the payload reaching the execution sink.

The injection point (e.g., 182) is identified as the FontMatrix parser in PreCompileFonto, where the PDF metadata is extracted and processed. The diagnosis module (e.g., 150) traces the attack vector, showing that the manipulated FontMatrix field bypasses any sanitization and directly reaches an execution context. The vulnerability is classified as context-sensitive injection, where the attacker's input undergoes transformations but remains exploitable.

Based on its analysis, the diagnosis module (e.g., 150) generates a root cause report (e.g., 152) that highlights: (i) an execution trace leading to the attack, including all key branches, (ii) an exact injection point in PreCompileFonto, pinpointing where untrusted input first enters, and (iii) a recommended patch suggesting that users implement strict input validation for PDF metadata and prohibit the execution of dynamically generated functions to prevent the code injections.

Mozilla addressed CVE-2024-4367 by introducing input validation checks and removing the use of new Function(for processing FontMatrix metadata, which aligned with the diagnosis module's suggested fix and validated its effectiveness in diagnosing real-world vulnerabilities.

The example diagnosis in FIG. 4E demonstrates the effectiveness of the diagnosis module (e.g., 150) of the exemplary system in diagnosing code injection vulnerabilities in applications. By leveraging event tracking, program reconstruction, and iterative symbolic analysis, the diagnosis module (e.g., 150) can reconstruct the execution trace, identify the root cause, and provide actionable remediation steps. Unlike current runtime monitoring systems that focus only on attack symptoms, the exemplary system, via the diagnosis module (e.g., 150), enables users to eliminate systemic weaknesses, preventing recurring exploits.

### Experimental Results and Additional Examples

A study was conducted to develop two experimental systems, referred to as a Code Injection Defense (CoInDef) system and a Code Injection Diagnosis (CoInDx) system, respectively, as described in relation to FIGS. 1-4. Both experimental systems were configured to detect a code injection attack before executing an application, but only the second experimental system (CoInDx) included a diagnosis module (e.g., 150) configured to determine the point of injection (e.g., 182) of a code injection attack.

### Experimental System #1

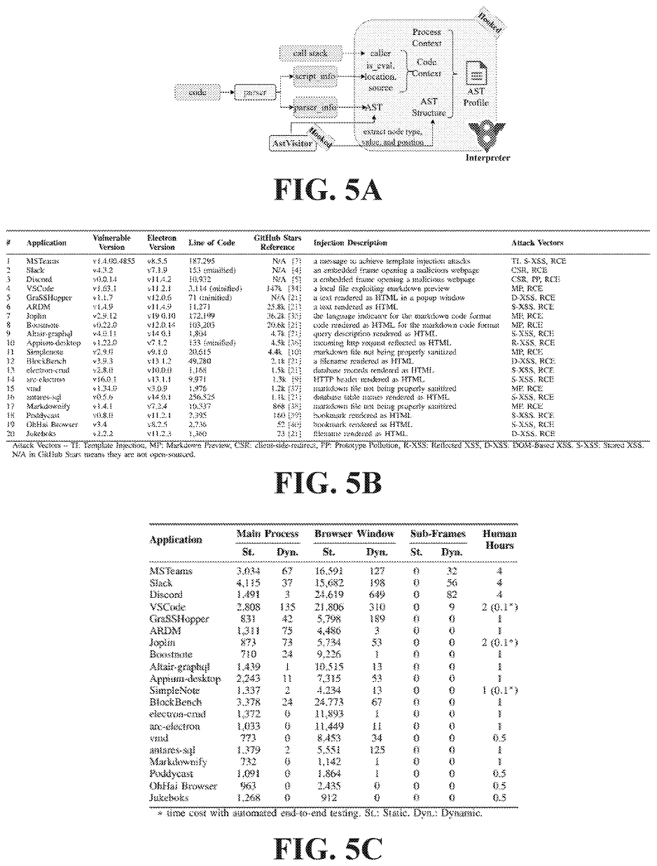

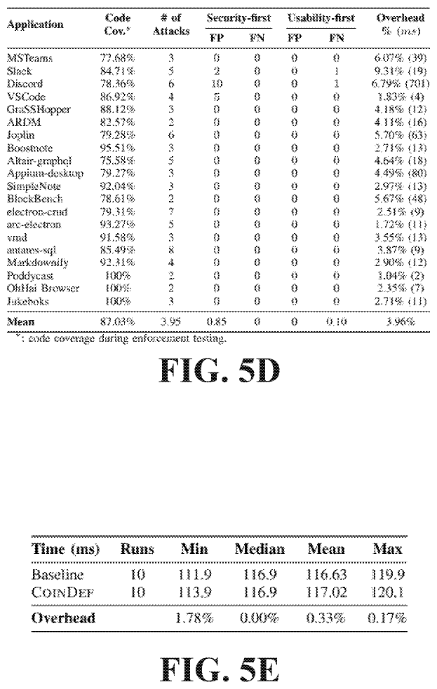

Implementation. FIG. 5A shows an implementation of the first experimental system (CoInDef). As shown, the first experimental system integrated instrumentation hooks into V8's interpreter to gather AST node information, modeling both static and dynamic code behaviors. haviors.

When a code was processed, the language parser tokenized it and constructed two objects: script info and parser_info. The objects contained metadata about the script, including the AST, source location, text range, and the origin of the code (e.g., static or dynamic). Before bytecode generation began, the first experimental system collected contextual information by examining the JavaScript stack frames provided by V8, selecting the top frame as the caller. The first experimental system extracted the dynamic code's location if sourced from eval-like APIs to establish the code context. During bytecode generation, the first experimental system hooked into the base AstVisitor functions to extract node type, value, and position within the AST. The first experimental system did not profile internal JavaScript functions in NodeJS and Electron applications, as the internal JavaScript functions were loaded before the user program and were immutable. To annotate processes, the first experimental system utilized hooks in Electron's web frame delegates. V8's Isolate represented isolated instances of the V8 engine, with the main process running NodeJS's JavaScript context and browser windows running standard JavaScript with additional Electron APIs. By hooking into Electron, the first experimental system identified the process creating the Isolate and annotated the process context accordingly.

The modifications for AST profile generation and enforcement were minimal, comprising fewer than 150 lines of code in V8 and an additional 500+ lines in two self-contained C++ files for logging and validation.

Effectiveness Evaluation. To evaluate the effectiveness and practicability of the first experimental system for protecting users from code injection attacks, the study used it on 20 applications vulnerable to code injection and RCE. The study selected the 20 applications from the GitHub Advisory Database [41], articles, and technical blogs [4], [5], [7], [8], [34] for their broad representation across software categories, scales, vulnerability types, and use cases.

FIG. 5B shows the selected 20 applications vulnerable to code injection and RCE attacks. In FIG. 5B, the code injection points of the vulnerabilities fall into three categories: messages, remote resources, and markdown files, covering the prevalent code injection attack vectors in Electron applications, including template injection, markdown preview, client-side redirect, prototype pollution, and all types of cross-site scripting (XSS). Among the attack vectors, client-side-redirect was particularly threatening in Electron applications and was not handled in [20], [21], because it opened a new website and took over the BrowserWindow, resulting in a legitimate call chain through IPC to the MainProcess. For example, collaboration applications such as Microsoft Teams, Slack, and Discord have injection points in their messaging features. In the case of Microsoft Teams, an attacker could exploit a vulnerability in rendering the display name of a mentioned user in a group chat to inject code into AngularJS's template engine. For Slack, the injection point was a malicious file uploaded tofile.slack.com and then sent to a victim via messaging. Similarly, for Discord, attackers could inject malicious code through messages. These two attacks leveraged malicious iframes and a vulnerability in Electron to launch a client-side redirect attack that loaded attacker-controlled content into the BrowserWindow, polluting the prototypes of certain built-in functions to achieve RCE. Some applications loaded remote resources, and injection points could be found within these resources. For example, in electron-crud, attackers could inject JavaScript code into the records of the connected database to launch a stored XSS. The malicious records allowed attackers to execute arbitrary code. Productivity applications such as VSCode have injection points in Markdown files that could contain HTML payloads that were not properly sanitized. When users interact with the Markdown files, the injected code executes, resulting in RCE.

To achieve realistic testing, the study used the vulnerable versions of each application listed in FIG. 5B, ensuring that all code injection attacks were new (e.g., 0-day) for each application, and the first experimental system was agnostic to these attack vectors. All the attack payloads were modified without harming the end host, but they triggered logs indicating it was an attack. Specifically, for applications exploited by malicious messages, the study used an MITM proxy to inject malicious payloads into the messages. For example, to exploit Microsoft Teams, the study first logged into Microsoft Teams with the first experimental system enabled as a victim. Then, the study used another account to send a message to the victim. The message was hijacked and injected with a malicious payload. The study then observed whether the malicious payload was executed to log the compromise indicator at each step in the attack chain. The study injected code into the remote content of applications that exploit them. For example, to exploit electron-crud, the study created a MySQL database and inserted a malicious record. Then, the study used electron-crud to read the malicious record to compromise the application. For applications exploited by markdown previews, the study crafted malicious markdown files and opened the files with those applications.

Using the AST profiling methods (e.g., static and dynamic profiling), the first experimental system collected AST profiles for all 20 applications. FIG. 5C shows the details of the collected AST profiles, along with the human effort required for the collection, measured in hours. The AST profiles were organized by process (e.g., MainProcess, BrowserWindow, SubFrames) and type (e.g., static or dynamic). Only three collaborative applications (e.g., Microsoft Teams, Slack, and Discord) and VSCode exhibited dynamic code in SubFrames. This was because collaborative applications included in-app view features, while VSCode executed extensions in isolated environments. The evaluation results showed that 18 of the 20 applications generated and ran code dynamically, with more complex applications producing and executing more dynamic code. The applications also ran more dynamic code within the BrowserWindow process than in MainProcess, since users interacted with user interface components, triggering dynamic code generation in BrowserWindow. Achieving a converged state of learned AST profiles required about 4 hours for complex applications and about 30 minutes for simpler ones, as shown in FIG. 5C. In the converged state, the number of AST profiles no longer increased, indicating that the AST profiling in the first experimental system fully covered the necessary code paths.

When learning was complete, the first experimental system entered the enforcing mode for each application and used it as a daily driver for a month, during which each application was attacked. The study evaluated the first experimental system across two security modes: security-first and usability-first. The default mode, security-first, disabled SubFrames from loading cross-origin resources (e.g., S.SubFrame=false) and rejected unknown same-origin content in BrowserWindow (e.g., S.SameOriginlnBrowser=false) (see FIG. 3D). The alternative mode, usability-first, permitted both cross-origin resource loading in SubFrames and same-origin content in BrowserWindow to prioritize flexibility and usability.

To evaluate the defensive mechanism of the first experimental system, the study adopted function-level code coverage on first-party code, as defined by V8 [42]. The study focused on function-level rather than block-level code coverage, as the first experimental system enforced the integrity of the AST profile for JavaScript functions rather than their individual blocks. Once a function passed validation, it could execute in full. The study used Acorn [43], a JavaScript parser, to count the number of functions in the first-party code as ground truth. During the testing phase, the study logged the number of functions invoked to calculate the test coverage.

FIG. 5D shows the effectiveness of the first experimental system under enforcement. For simple and small applications (3 out of 20), the experimental system achieved 100% code coverage. For medium-sized applications (5 out of 20), the first experimental system achieved over 90% code coverage. For more complex applications (12 out of 20), such as Slack and VSCode, the first experimental system achieved over 75% code coverage, indicating robust test coverage across varying levels of application complexity.

In FIG. 5D, the study conducted 79 attacks across 20 applications, with each application facing between 2 and 8 targeted attacks. Each attack targeted a specific code injection point. However, in some cases, RCE required a series of attacks in a kill chain. For example, 6 attacks launched against Discord formed two separate attack sessions, each involving three interdependent attacks (e.g., client-side-redirect, prototype pollution, and RCE) that combined to achieve RCE. In the security-first mode, the first experimental system blocked all code-injection attempts across all 20 applications, with few false positives. In usability-first mode, the first experimental system allowed two code injections to bypass protection in two applications, but still prevented the final RCE with zero false positives. This result suggested that for applications used locally without loading remote content (e.g., GraSSHopper, SimpleNote, Markdownify), the first experimental system prevented code injection attacks under both modes. For applications (e.g., Slack, Discord) with more interactive features, such as in-app view functionality, the first experimental system missed one attack targeting SubFrames, but the first experimental system still delivered robust protection by securing critical processes in the BrowserWindow and MainProcess contexts, blocking any code injections into these processes and subsequent RCE attacks.

In the evaluation, the study observed 17 false positives in the security-first mode across 3 of the 20 applications, whereas the usability-first mode produced none. The 17 FP cases fell into two categories: (i) unlearned features provided by remote content and (ii) unlearned updates. Specifically, 12 false positives resulted from in-app view features in Slack and Discord, such as video playback or file previews within isolated SubFrames. In security-first mode, scripts running within SubFrames were disabled, blocking the in-app view. Although this resulted in an empty video window, users could still click the in-app view link to open it in an external browser. The remaining five false positives occurred in VSCode due to extensions that introduced new script files. Users could enable learning mode for these extensions to gather the necessary AST profiles.

In the usability-first mode, the study observed 2 false negatives, whereas the security-first mode produced none. Both false negatives stemmed from exploits targeting in-app view features. Specifically, these exploits injected code into trusted SubFrames, attempting to escalate privileges by controlling a BrowserWindow. Although the injected code in SubFrames succeeded in accessing a BrowserWindow object, the first experimental system blocked further code execution in the BrowserWindow process due to its security enforcement upon the BrowserWindow process. Therefore, the first experimental system prevented the RCE even though the attack succeeded in the initial stage in SubFrames.

The evaluation indicated that the impact of FP and FN on the user experience was minimal. If users want to use the in-app view features, they can opt for the usability-first mode, which maintains security in the main application.

Runtime Overhead Evaluation. The study conducted two runtime performance evaluations to assess the runtime overhead introduced by the first experimental system to applications. The study performed runtime performance evaluations on Ubuntu 22.04, equipped with an Intel CPU E5-2680v3 operating at 2.50 GHz and 64 GB of DDR4 memory running at 2133 MHz.

In the first runtime performance evaluation, the study measured the overhead imposed by the first experimental system during page loading. The study initiated a timer when the navigationStart event was triggered and concluded the measurement when the loadEventEnd event was fired on the initial web page. This time measurement represented the page load time. Because some applications loaded remote websites as their initial page (e.g., Slack and Discord), the study ran the application once before the evaluation to warm up the network cache, thereby reducing the impact of network latency. For more complex applications, such as VSCode, which span multiple pages/frames, the study measured overhead only for the main frame (e.g., the VSCode editor window).

To calculate the overhead for page load, the study executed the application ten times with and without the first experimental system, selecting the median time cost. As shown in FIG. 5D, the first experimental system had an average overhead of 3.96%, with a maximum of 9.31% for Slack and a minimum of 1.04% for Poddycast. Although overhead for Slack was high, the additional time contributed by the first experimental system was only 19 milliseconds. The first experimental system exhibited higher overhead for applications that required network connections, such as Microsoft Teams and Discord. For example, Discord performed update checks before loading the first page, and the testing environment's first page included rich content with 57 script files sourced from discord.com. The 57 script files triggered validation for over 20,000 AST profiles.

Consistent with a previous study [21], the study utilized the Speedometer 2.0 benchmark suite [49] to evaluate the overhead for user interactions. The Speedometer 2.0 benchmark suite included 17 TodoMVC applications. The benchmark simulated user actions of adding, completing, and removing items from a to-do list. In this process, the benchmark sequentially executed the 17 TodoMVC applications. For each application, the benchmark began by adding 100 items, one at a time, each containing some content. Subsequently, the benchmark iteratively marked each item as complete. Finally, the benchmark was concluded by removing all the items. The study repeated this process ten times, with and without the first experimental system.

FIG. 5E shows the runtime overhead of the 17 TodoMVC applications, with or without the first experimental system running thereon, during user interaction. In FIG. 5E, the time to run all 17 TodoMVC applications ranged (i) from 111.9 milliseconds to 119.9 milliseconds for the baseline version of the applications (without the first experimental system running thereon), and (ii) from 113.9 milliseconds to 120.1 milliseconds for the version with the first experimental system. The interactive overhead ranged from 0 to 1.78%. The experimental system was configured not to introduce runtime overhead for user interaction because the first experimental system did not hook into function calls. Therefore, the study applied all data samples to estimate their confidence intervals and concluded that the two sample sets originated from the same distribution, indicating that the first experimental system did not introduce any runtime overhead during user interactions. In scenarios where the application loaded remote scripts, there was minimal overhead during app startup (see FIG. 5D).

The storage overhead grew linearly (e.g., O(n), where n is the number of functions defined in the application). The largest storage overhead (e.g., Discord) was 2 MB on disk and 10 MB in memory, which was negligible.

### Experimental System #2

Implementation. The study implemented the second experimental system to balance its security, performance, and usability. To recover full execution traces in an event-driven JavaScript environment, the study modified the JavaScript prototype chain to be read-only, enabling users to integrate the second experimental system into their codebase without modifying the underlying JavaScript runtime environment. By intercepting event registrations and executions through prototype modification, the second experimental system tracked event bindings and reconstructed call stacks without interfering with application logic. Since JavaScript allowed prototype modifications but restricted certain built-in functions from being redefined, making the JavaScript prototype chain read-only prevented tampering while maintaining compatibility with real-world applications. Furthermore, this method was more practical for real-world adoption than alternative approaches, such as instrumenting the low-level browser engine or the Node.js native code. While deeper instrumentation could provide stronger security guarantees by preventing adversaries from tampering with the event tracking system, it is less practical due to the complexity of modifying and maintaining a custom JavaScript runtime for end users.

To generate a recomposed simplified program for symbolic execution, the second experimental system used Acorn [24′], a JavaScript AST parser, alongside ESLint [25′], a static analysis tool, to extract and recompose relevant code from the recovered stack trace. In the second experimental system, the program reconstruction process included: (i) using Acorn to parse JavaScript source files into an AST, (ii) using ESLint to perform static analysis to track function dependencies, identify closure variables, and ensure the integrity of the recomposed program, and (iii) replacing any function or variable unresolved in the recomposed program with a symbolic representation, ensuring that symbolic execution could generalize execution traces while maintaining correctness.

For symbolic execution, the second experimental system used ExpoSE [26′], a JavaScript symbolic execution engine running within the Electron runtime, to support both web-based JavaScript applications and native JavaScript environments (e.g., Node.js and Electron applications). The Electron-based runtime enabled the second experimental system to execute recomposed programs in an environment that mirrored real-world JavaScript execution, ensuring accurate symbolic state propagation. By running within Electron, the second experimental system could handle browser-based execution contexts, event-driven execution models, and native API interactions, making it more versatile than approaches that rely on browser-specific or native-only execution models. ExpoSE provided fine-grained symbolic constraint tracking, enabling the second experimental system to explore execution paths while maintaining compatibility with modern JavaScript applications.

Given the vulnerable execution trace identified, the injection point, and attack vector determined, the second experimental system generated a root cause report to assist users in understanding and mitigating the vulnerability through GPT-4o-mini. The root cause report included: (i) the reconstructed execution trace, highlighting the key program branches leading to injection, (ii) the injection point, providing the exact source code location where attacker-controlled data first entered the execution flow, and (iii) suggested patch recommendations, including mitigation strategies such as input sanitization, secure API replacements, or event handler restrictions.

Accuracy Evaluation. The study evaluated the second experimental system's accuracy in detecting code injection vulnerabilities using SecBench.js [18′], a benchmark dataset configured to assess JavaScript security analysis tools. SecBench.js included 40 code injection vulnerabilities and 101 command injection vulnerabilities in Node Package Manager (NPM) modules, making it a suitable testbed for evaluating the second experimental system's detection capabilities.

The study selected SecBench.js as the benchmark dataset for 3 reasons. First, SecBench.js includes real-world vulnerabilities in JavaScript libraries and frameworks. Second, SecBench.js includes diverse attack patterns that cover how attacker-controlled input propagates to injection sinks, including direct user input, event-driven execution, and indirect control-flow dependencies. Third, SecBench.js provides ground-truth labels, allowing the study to measure the second experimental system's true positive rate (TPR) and false positive rate (FPR) against known vulnerabilities.

To set up the accuracy evaluation, the study modified the current testing harnesses for exploiting those vulnerabilities. Specifically, the study first added the instrumentation code for tracking events. Then, the study configured the exploits to dump the stack trace by raising a customized Error exception. In other words, when the exploiting payload reached the injection sink, a stack trace could be directly dumped. Next, the second experimental system used the stack trace and event logs to identify the root cause.

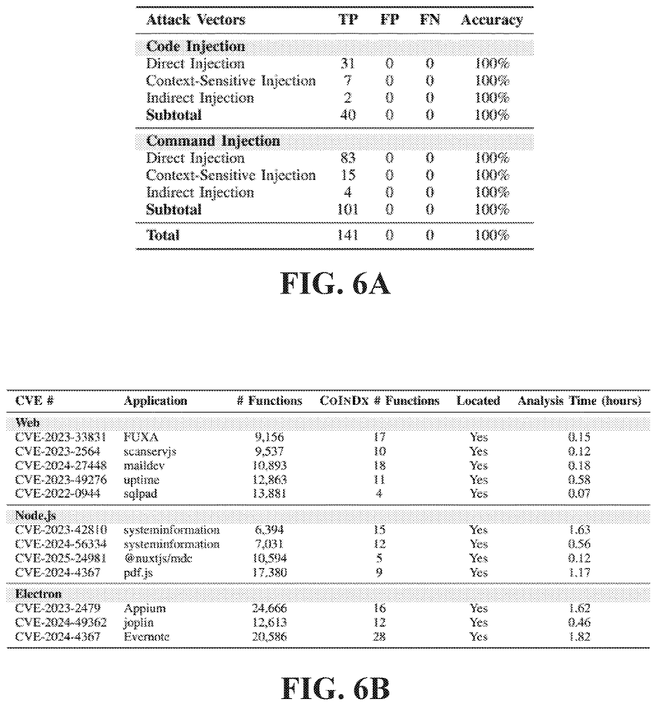

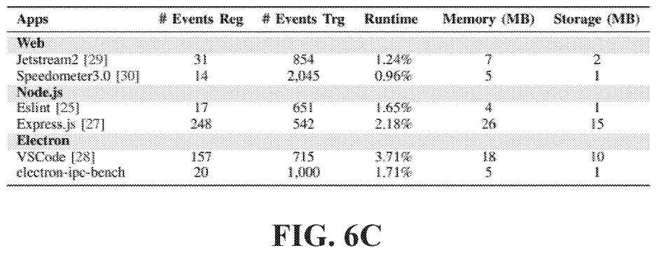

FIG. 6A shows the detection performance of the second experimental system on the SecBench.js dataset, which included 40 code injection vulnerabilities and 101 command injection vulnerabilities. The study defined a true positive (TP) as a case in which the second experimental system correctly identified the root cause by locating the exact injection point and the execution trace. A false positive (FP) occurred when the second experimental system incorrectly identified an injection point that was not the actual root cause. A false negative (FN) occurred when the second experimental system failed to detect the vulnerability. Since all modules in the benchmark dataset were exploitable, TN was zero for each attack vector.

For code injection vulnerabilities, the second experimental system identified 31 cases as direct injection, 7 cases as context-sensitive injection, and 2 cases as indirect injection. Among the identified 31 cases, the second experimental system pinpointed all the root causes. For command injection vulnerabilities, the second experimental system identified 83 cases as direct injection, 15 cases as context-sensitive injection, and 4 cases as indirect injection. Among the identified 83 cases, the second experimental system pinpointed all the root causes.

The results in FIG. 6A show the second experimental system's ability to detect and attribute code injection vulnerabilities, with most failures occurring in complex indirect injection flows where symbolic execution constraints could not be fully resolved. The high success rate across direct and context-sensitive injections indicated that the second experimental system effectively reconstructed execution traces and identified attacker-controlled inputs.

Real-World Exploit Locating Evaluation. To evaluate whether the second experimental system could locate and analyze real-world exploits, the study used it on 11 real-world JavaScript applications containing 12 exploits, across five Web, three Node.js, and three Electron applications.

To evaluate whether the second experimental system could identify and analyze real-world exploits, the study tested the system using 11 real-world JavaScript applications comprising 12 known exploits: 5 Web applications, 3 Node.js applications, and 3 Electron applications.

To set up this evaluation, the study hosted the applications in a controlled environment, then ran them with the second experimental system to capture event registration, triggering, and handling. To simulate the external monitoring tools, the study configured the exploits to dump the stack trace by raising a customized Error exception. Next, the study injected known exploits into the applications to simulate real-world attacks. The study then analyzed the event logs generated by the second experimental system to identify the root cause of the vulnerabilities. Finally, the study compared the results of the second experimental system with official security advisories and developer patches to validate its effectiveness in locating and analyzing real-world exploits.

FIG. 6B shows the results of the real-world exploit evaluation. For each application in FIG. 6B, the study reported (i) the number of functions defined in the original application, (ii) the number of functions the second experimental system extracted for iterative symbolic analysis, (iii) whether the second experimental system located the root cause of the vulnerability, and (iv) the analysis time used by second experimental system to locate the root cause. Additionally, the second experimental system suggested a patch to fix the vulnerability, which was compared with official security advisories and developer patches to validate its effectiveness in pinpointing the root cause of the vulnerability.

In FIG. 6B, the second experimental system identified the root causes of vulnerabilities across all five applications, demonstrating its effectiveness in analyzing client-side rendering and event-driven execution models. The analysis time ranged from 0.15 to 0.58 hours, with an average of 0.22 hours per application. The results showed that the experimental system could identify the root cause of vulnerabilities in web applications, making it a valuable tool for securing client-side applications.

In FIG. 6B, for Node.js applications, the second experimental system identified the root causes of vulnerabilities across all five applications, demonstrating its effectiveness in analyzing server-side processing and high-throughput workloads. The analysis time ranged from 0.12 to 1.63 hours, with an average of 0.87 hours per application. The results showed that the second experimental system could identify the root cause of vulnerabilities in Node.js applications, making it a valuable tool for securing server-side applications.

In FIG. 6B, for Electron applications, the experimental system identified the root causes of vulnerabilities across all five applications, demonstrating its effectiveness in analyzing multi-process desktop applications. The analysis time ranged from 0.46 to 1.82 hours, with an average of 1.30 hours per application. The results showed that the second experimental system could identify the root cause of vulnerabilities in Electron applications, making it a valuable tool for securing desktop applications.

Overhead Evaluation. The study evaluated the runtime overhead introduced by the second experimental system when deployed in real-world applications. Specifically, the study measured the overhead incurred during event registration, triggering, and handling tracking, as these operations form the core of the second experimental system's runtime instrumentation. The evaluation considered applications across three JavaScript execution environments: web, Node.js, and Electron.

For web applications, the study used two benchmarks configured to measure browser responsiveness, providing a standardized way to assess the impact of the second experimental system on JavaScript execution performance. For Node.js, the study selected two applications: ESLint [25′], a static analysis tool used by every JavaScript developer, and Express.js [27′], a popular JavaScript backend framework. The two applications allowed the study to evaluate the second experimental system's overhead in both computationally intensive workloads (e.g., static analysis) and high-throughput server applications. For Electron, the study selected VSCode [28′], a widely used editor, known for its large-scale Electron-based architecture and comprehensive end-to-end testing. Additionally, the study used Electron-IPC-Bench, a benchmark configured to stress IPC messages in Electron applications, allowing the study to measure the impact of the second experimental system on messaging event efficiency. By evaluating a diverse set of real-world applications, the study evaluated the second experimental system's runtime performance across various execution models, including client-side rendering, backend processing, and multi-process desktop applications.

To set up this evaluation, the study ran every application in Electron with event-tracking hooks installed. For example, the study opened the web benchmarks in Electron's browser window. For Node.js and Electron applications, the study ran the built-in test suites to measure the overhead. When running the test suites, the study measured the time the application took to register and consume events. The study also measured the memory overhead introduced by the second experimental system by comparing the memory usage of the application with and without the second experimental system. Additionally, the study measured the storage overhead by measuring the size of the event logs generated by the second experimental system on disk.

FIG. 6C shows the overhead evaluation results for the second experimental system across various applications. For web applications, the overhead was minimal, with a 1.24% increase in runtime, because they were event-driven and had fewer events than server applications. For Node.js applications, the overhead was also negligible, with a 2.18% increase in runtime, due to the lightweight nature of the second experimental system, which only tracked events during application execution. For Electron applications, the overhead was higher, with a less than 3.71% increase in runtime, because they were more complex and had a higher number of events than web and Node.js applications. Overall, the evaluation results in FIG. 6C demonstrated that the second experimental system introduced minimal overhead when deployed in real-world applications, making it practical for use in production environments. The memory and storage overhead of storing these logs was less than 10 MB on average.

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special-purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with programming techniques with rule-based logic and other logic to accomplish the various connection steps, processing steps, comparison steps, and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” mean “including but not limited to,” and are not intended to exclude, for example, other additives, components, integers, or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference to each various individual and collective combinations and permutations of these may not be explicitly disclosed, each is specifically contemplated and described herein, for all methods and systems. This applies to all aspects of this application, including, but not limited to, steps in disclosed methods. Thus, if there are a variety of additional steps that can be performed, it is understood that each of these additional steps can be performed with any specific implementation or combination of implementations of the disclosed methods.

The following patents, applications, and publications, as listed below and throughout this document, are hereby incorporated by reference in their entirety herein.

### REFERENCE LIST #1

[1] Electron npm trends, https://npmtrends.comelectr on, (Accessed on Aug. 30, 2024).
[2] How water labbu exploits electron-based applications, https://www.trendmicro.com/en za/research/22/j/howwater-labbu-exploits-electron-based-applications.html, (Accessed on Aug. 30, 2024).
[3] Cve—cve-2021-21220, https://cve.mitre.org/cgi-bin/cvename.cgi?name=CVE-2021-21220, (Accessed on Aug. 30, 2024).
[4] Slack—report #783877—emote code execution in slack desktop apps+bonus—hackerone, https://hackerone.com/reports/783877/, (Accessed on Sep. 1, 2024).
[5] Mksb(en): Discord desktop app rce, https://mksben. 10.cm/2020/10/discord-desktop-rce.html, (Accessed on Aug. 30, 2024).
[6] Rce in mattermost desktop earlier than 4.2.0—dev community, https://dev.to/nlowe/rce-in-mattermost-desktop-earlier-than-420-5aef, (Accessed on Sep. 1, 2024).
[7] Oskarsve/ms-teams-rce, https://github.com/oskarsve/ms-teams-rce/, (Accessed on Sep. 1, 2024).
[8] Cve-2021-28471—security update guide-microsoft-remote development extension for visual studio code remote code execution vulnerability, https://msrc.microsoft.com/update-guide/vulnerability/CVE-2021-28471, (Accessed on Sep. 1, 2024).
[9] Execution with unnecessary privileges in arc-electron ghsa-v3wr-67px-44xg⋅github advisory database, https://github.com/advisories/GHSA-v3wr-67px-44xg, (Accessed on Sep. 1, 2024).
[10] Xss vulnarability in markdown mode, https://github.com/Automattic/simplenote-electron/issues/487, (Accessed on Sep. 1, 2024).
[11]B. Stock, S. Lekies, T. Mueller, P. Spiegel, and M. Johns, “Precise client-side protection against dom-based cross-site scripting,” in Proceedings of the 23rd USENIX Security Symposium (Security), San Diego, CA, August 2014, pp. 655-670.
[12]B. Stock, S. Pfistner, B. Kaiser, S. Lekies, and M. Johns, “From facepalm to brain bender: Exploring client-side cross-site scripting,” in Proceedings of the 22nd ACM Conference on Computer and Communications Security (CCS), Denver, CO, October 2015, pp. 1419-1430.
[13]P. Vogt, F. Nentwich, N. Jovanovic, E. Kirda, C. Kruegel, and G. Vigna, “Cross site scripting prevention with dynamic data tainting and static analysis,” in Proceedings of the 14th Annual Network and Distributed System Security Symposium (NDSS), San Diego, CA, February 2007.
[14]P. Soni, E. Budianto, and P. Saxena, “The sicilian defense: Signature-based whitelisting of web javascript,” in Proceedings of the 22nd ACM Conference on Computer and Communications Security (CCS), Denver, CO, October 2015.
[15]S. Lekies, B. Stock, and M. Johns, “25 million flows later: Large-scale detection of dom-based xss,” in Proceedings of the 20th ACM Conference on Computer and Communications Security (CCS), Berlin, Germany, October 2013, pp. 1193-1204.
[16]C.-A. Staicu, M. Pradel, and B. Livshits, “Synode: Understanding and automatically preventing injection attacks on node.js.,” in Proceedings of the 2018 Annual Network and Distributed System Security Symposium (NDSS), San Diego, CA, February 2018.
[17]S. H. Jensen, P. A. Jonsson, and A. Møller, “Remedying the eval that men do,” in Proceedings of the 2012 International Symposium on Software Testing and Analysis, 2012, pp. 34-44.
[18]I. Koishybayev and A. Kapravelos, “Mininode: Reducing the attack surface of node.js applications,” in 23rd International Symposium on Research in Attacks, Intrusions and Defenses (RAID 2020), San Sebastian, Spain, October 2020.
[19] Electronjs electron: Security vulnerabilities, cves, https://www.cvedetails.com/vulnerability-list/vendorid-17824/productid-44696/Electronjs-Electron.html, (Accessed on Nov. 5, 2024).
[20]F. Xiao, Z. Yang, J. Allen, G. Yang, G. Williams, and W. Lee, “Understanding and mitigating remote code execution vulnerabilities in cross-platform ecosystem,” in Proceedings of the 29th ACM Conference on Computer and Communications Security (CCS), Los Angeles, US, November 2021, pp. 2975-2988.
[21]Z. Jin, S. Chen, Y. Chen, H. Duan, J. Chen, and J. Wu, “A security study about electron applications and a programming methodology to tame dom functionalities,” in Proceedings of the 2023 Annual Network and Distributed System Security Symposium (NDSS), San Diego, CA, February 2023.
[22]M. M. Ali, M. Ghasemisharif, C. Kanich, and J. Polakis, “Rise of inspectron: Automated black-box auditing of cross-platform electron apps,” in Proceedings of the 33rd USENIX Security Symposium (Security), Philadelphia, PA, August 2024.
[23]Z. Su and G. Wassermann, “The essence of command injection attacks in web applications,” in Proceedings of the 33rd ACM Symposium on Principles of Programming Languages (POPL), Charleston, South Carolina, January 2006.
[24]C. Reis, A. Moshchuk, and N. Oskov, “Site isolation: Process separation for web sites within the browser,” in Proceedings of the 28th USENIX Security Symposium (Security), Santa Clara, CA, August 2019.
[25] Nvd—cve-2020-15096, https://nvd.nist.gov/vuln/detail/CVE-2020-15096, (Accessed on Sep. 23, 2023).
[26] Nvd—cve-2020-15215, https://nvd.nist.gov/vuln/detail/CVE-2020-15215, (Accessed on Sep. 23, 2023).
[27] Cve—cve-2020-15174, https://cve.mitre.org/cgi-bin/cvename.cgi?name=2020-15174, (Accessed on Aug. 30, 2024).
[28] Security fix for arbitrary code execution—huntr.dev by huntr-helper pull request #1 mikeerickson/cdmessenger, https://github.com/mikeerickson/cd-mess enger/pull/1, (Accessed on Sep. 1, 2024).
[29]D. Wagner and P. Soto, “Mimicry attacks on host-based intrusion detection systems,” in Proceedings of the 9th ACM Conference on Computer and Communications Security (CCS), Washington, DC, October 2002, pp. 255-264.
[30] Cve—cve-2022-29247, https://nvd.nist.gov/vuln/detail/CVE-2022-29247, (Accessed on Aug. 30, 2024).
[31] Codeinjection, https://codeql.github.com/codeql-standard-libraries/javascript/semmle/javascript/security/dataflow/CodeInjectionCustomizations.qll/module.CodeInjectionCustomizations$CodeInjection.html, (Accessed on Oct. 28, 2024).
[32]R. Jahanshahi, B. A. Azad, N. Nikiforakis, and M. Egele, “Minimalist: Semi-automated debloating of {php}web applications through static analysis,” in Proceedings of the 32nd USENIX Security Symposium (Security), Anaheim, CA, August 2023.
[33]B. A. Azad, P. Laperdrix, and N. Nikiforakis, “Less is more: Quantifying the security benefits of debloating web applications,” in Proceedings of the 28th USENIX Security Symposium (Security), Santa Clara, CA, August 2019.
[34] Cve-2021-43908-security update guide-microsoft-visual studio code spoofing vulnerability, https://msrc.microsoft.com/update-guide/vulnerability/CVE2021-43908, (Accessed on Sep. 1, 2024).
[35] Joplin desktop app vulnerable to cross-site scripting cve-2022-45598 ⋅github advisory database, https://github.com/advisories/GHSA-h6c2-879r-jffh, (Accessed on Sep. 1, 2024).
[36] Appium-desktop os command injection vulnerability cve-2023-2479 github advisory database, https://github.com/advisories/GHSA-xq6j-x8pq-g3 gr, (Accessed on Sep. 1, 2024).
[37] Cross site scripting vulnerability, https://github.com/yoshuawuyts/vmd/issues/137, (Accessed on Sep. 1, 2024).
[38] Markdownify subject to remote code execution via malicious markdown file cve-2022-41709 github advisory database, https://github.com/advisories/GHSA-c942-mfmp-p4fh, (Accessed on Sep. 1, 2024).
[39] Os command injection vulnerability found in poddycast, https://huntr.dev/bounties/1624637557081-MrChuckomo/poddycast/, (Accessed on Sep. 1, 2024).
[40] Xss vulnerability issue #23.ohhaibrowser/browser, https://github.com/OhHaiBrowser/Browser/issues/23, (Accessed on Sep. 1, 2024).
[41] Github advisory database, https://github.com/advisor ies?query=type:reviewed+ecosystem:npm, (Accessed on Sep. 1, 2024).
[42] Javascript code coverage-v8, https://v8.dev/blog/javascript-code-coverage, (Accessed on Sep. 1, 2024).
[43] Acornjs/acorn: A small, fast, javascript-based javascript parser, https://github.com/acornjs/acorn, (Accessed on Aug. 29, 2024), 2024.
[44]U. Iqbal, P. Snyder, S. Zhu, B. Livshits, Z. Qian, and Z. Shafiq, “AdGraph: A graph-based approach to ad and tracker blocking,” in Proceedings of the 41st IEEE Symposium on Security and Privacy (S&P), Virtual Conference, May 2020, pp. 763-776.
[45]J. Allen, Z. Yang, M. Landen, R. Bhat, H. Grover, A. Chang, Y. Ji, R. Perdisci, and W. Lee, “Mnemosyne: An Effective and Efficient Postmortem Watering Hole Attack Investigation System,” in Proceedings of the 27th ACM Conference on Computer and Communications Security (CCS), Virtual Event, November 2020, pp. 787-802.
[46]Z. Yang, J. Allen, M. Landen, R. Perdisci, and W. Lee, “Trident: Towards detecting and mitigating web-based social engineering attacks,” in Proceedings of the 32nd USENIX Security Symposium (Security), Anaheim, CA, August 2023, pp. 1681-1698.
[47]B. Li, P. Vadrevu, K. H. Lee, and R. Perdisci, “Jsgraph: Enabling reconstruction of web attacks via efficient tracking of live in-browser javascript executions,” in Proceedings of the 2018 Annual Network and Distributed System Security Symposium (NDSS), San Diego, CA, February 2018.
[48]Q. Chen, P. Snyder, B. Livshits, and A. Kapravelos, “Detecting Filter List Evasion With Event-Loop-Turn Granularity JavaScript Signatures,” May 2021.
[49] Speedometer 2.0, https://browserbench.org/Speedom eter2.0/, (Accessed on Sep. 1, 2024).
[50]A03 injection-owasp top 10:2021, https://owasp.org/Top10/A03 2021-Injection/, (Accessed on Sep. 1, 2024).
[51]X. Pan, Y. Cao, S. Liu, Y. Zhou, Y. Chen, and T. Zhou, “Cspautogen: Black-box enforcement of content security policy upon real-world websites,” in Proceedings of the 23rd ACM Conference on Computer and Communications Security (CCS), Vienna, Austria, October 2016, pp. 653-665.
[52]B. Amin Azad, R. Jahanshahi, C. Tsoukaladelis, M. Egele, and N. Nikiforakis, “AnimateDead: Debloating Web Applications Using Concolic Execution,” in Proceedings of the 32nd USENIX Security Symposium (Security), Anaheim, CA, August 2023.
[53]E. Trickel, F. Pagani, C. Zhu, L. Dresel, G. Vigna, C. Kruegel, R. Wang, T. Bao, Y. Shoshitaishvili, and A. Doupe, “Toss a Fault to Your Witcher: Applying Grey-box Coverage-Guided Mutational Fuzzing to Detect SQL and Command Injection Vulnerabilities,” in Proceedings of the 44th IEEE Symposium on Security and Privacy (S&P), San Francisco, CA, May 2023.
[54]A. Fass, M. Backes, and B. Stock, “Jstap: A static pre-filter for malicious javascript detection,” in Proceedings of the 35th Annual Computer Security Applications Conference (ACSAC), San Juan, Puerto Rico, December 2019, pp. 257-269.
[55]S. Li, M. Kang, J. Hou, and Y. Cao, “Mining Node.js Vulnerabilities via Object Dependence Graph and Query,” Tech. Rep.
[56]S. Li, M. Kang, J. Hou, and Y. Cao, “Detecting node.js prototype pollution vulnerabilities via object lookup analysis,” in Proceedings of the 29th ACM Joint Meeting on European Software Engineering Conference and Symposium on the Foundations of Software Engineering, 2021, pp. 268-279. [57]Z. Liu, K. An, and Y. Cao, “Undefined-oriented programming: Detecting and chaining prototype pollution gadgets in node.js template engines for malicious consequences,” in Proceedings of the 45th IEEE Symposium on Security and Privacy (S&P), San Francisco, CA, May 2024. [58]M. Kang, Y. Xu, S. Li, R. Gjomemo, J. Hou, V. N. Venkatakrishnan, and Y. Cao, “Scaling javascript abstract interpretation to detect and exploit node.js taint-style vulnerability,” in Proceedings of the 44th IEEE Symposium on Security and Privacy (S&P), San Francisco, CA, May 2023.
[59]J. Jueckstock and A. Kapravelos, “VisibleV8: In-browser Monitoring of JavaScript in the Wild,” in Proceedings of the Internet Measurement Conference (IMC), Amsterdam, Netherlands, October 2019.

### Reference List #2

[1′]B. Stock, F. A. U. Erlangen-nuremberg, S. Pfistner, B. Kaiser, F. A. U. Erlangen-nuremberg, S. Lekies, and M. Johns, “From Facepalm to Brain Bender: Exploring Client-Side Cross-Site Scripting Categories and Subject Descriptors,” Proceedings of the 22nd ACM SIGSAC Conference on Computer and Communications Security, pp. 1419-1430, 2015.
[2′]M. Steffens and B. Stock, “PMForce: Systematically Analyzing postMessage Handlers at Scale,” in Proceedings of the 2020 ACM SIGSAC Conference on Computer and Communications Security, 2020, pp. 493-505, ISBN: 9781450370899.
[3′]S. Lekies, B. Stock, and M. Johns, “25 million flows later: Large-scale detection of dom-based xss,” in Proceedings of the 20th ACM Conference on Computer and Communications Security (CCS), Berlin, Germany, October 2013, pp. 1193-1204.
[4′]M. Steffens, C. Rossow, M. Johns, and B. Stock, “Don't trust the locals: Investigating the prevalence of persistent client-side cross-site scripting in the wild,” in Proceedings of the 2020 Annual Network and Distributed System Security Symposium (NDSS), San Diego, CA, February 2020.
[5′]M. Shcherbakov, M. Balliu, and C.-A. Staicu, “Silent spring: Prototype pollution leads to remote code execution in node.js,” in Proceedings of the 32nd USENIX Security Symposium (Security), Anaheim, CA, August 2023.
[6′]C.-A. Staicu, M. Pradel, and B. Livshits, “Synode: Understanding and automatically preventing injection attacks on node.js.,” in Proceedings of the 2018 Annual Network and Distributed System Security Symposium (NDSS), San Diego, CA, February 2018.
[7′]F. Xiao, J. Huang, Y. Xiong, G. Yang, H. Hu, G. Gu, and W. Lee, “Abusing hidden properties to attack the node.js ecosystem,” in Proceedings of the 30th USENIX Security Symposium (Security), Virtual Conference, August 2021.
[8′]F. Xiao, Z. Yang, J. Allen, G. Yang, G. Williams, and W. Lee, “Understanding and mitigating remote code execution vulnerabilities in cross-platform ecosystem,” in Proceedings of the 29th ACM Conference on Computer and Communications Security (CCS), Los Angeles, US, November 2022, pp. 2975-2988.
[9′]S. Li, M. Kang, J. Hou, and Y. Cao, “Mining node.js vulnerabilities via object dependence graph and query,” in Proceedings of the 31st USENIX Security Symposium (Security), Boston, MA, August 2022.
[10′] Owasp top ten 2017, https://owasp.org/www-projecttop-ten/2017/Top 10.html.
[11′] Owasp top ten 2021, https://owasp.org/Top10/.
[12′]Z. Jin, S. Chen, Y. Chen, H. Duan, J. Chen, and J. Wu, “A security study about electron applications and a programming methodology to tame dom functionalities,” in Proceedings of the 2023 Annual Network and Distributed System Security Symposium (NDSS), San Diego, CA, February 2023.
[13′]X. Pan, Y. Cao, S. Liu, Y. Zhou, Y. Chen, and T. Zhou, “Cspautogen: Black-box enforcement of content security policy upon real-world websites,” in Proceedings of the 23rd ACM Conference on Computer and Communications Security (CCS), Vienna, Austria, October 2016, pp. 653-665.
[14′]P. Soni, E. Budianto, and P. Saxena, “The sicilian defense: Signature-based whitelisting of web javascript,” in Proceedings of the 22nd ACM Conference on Computer and Communications Security (CCS), Denver, CO, October 2015.
[15′]Z. Yang, S. Chung, J. Chen, R. Zhang, B. Saltaformaggio, and W. Lee, “Coindef: A comprehensive code injection defense for the electron framework,” in Proceedings of the 46th IEEE Symposium on Security and Privacy (S&P), San Francisco, CA, May 2025.
[16′]C. Yagemann, M. Pruett, S. P. Chung, K. Bittick, B. Saltaformaggio, and W. Lee, “{Arcus}: Symbolic root cause analysis of exploits in production systems,” in Proceedings of the 30th USENIX Security Symposium (Security), Virtual Conference, August 2021.
[17′]C. Yagemann, S. P. Chung, B. Saltaformaggio, and W. Lee, “Automated bug hunting with data-driven symbolic root cause analysis,” in Proceedings of the 28th ACM Conference on Computer and Communications Security (CCS), Seoul, South Korea, November 2021.
[18′]M. H. M. Bhuiyan, A. S. Parthasarathy, N. Vasilakis, M. Pradel, and C.-A. Staicu, “Secbench. js: An executable security benchmark suite for server-side javascript,” in International Conference on Software Engineering (ICSE), 2023.
[19′] Nvd—cve-2024-4367, https://nvd.nist.gov/vuln/detail/cve-2024-4367, 2024.
[20′]H. Hu, C. Qian, C. Yagemann, S. P. H. Chung, W. R. Harris, T. Kim, and W. Lee, “Enforcing unique code target property for control-flow integrity,” in Proceedings of the 25th ACM Conference on Computer and Communications Security (CCS), Toronto, ON, Canada, October 2018.
[21′]S. Forrest, S. Hofmeyr, and A. Somayaji, “The evolution of system-call monitoring,” in Proceedings of the Annual Computer Security Applications Conference (ACSAC), 2008.
[22′] Evernote 2023 recap, [Accessed 2025-02-14], 2024. [Online]. Available: https://evernote.com/blog/2023-recap.
[23′] Pdf.js—home, [Accessed 2025-02-14]. [Online]. Available: https://mozilla.github.io/pdf.js/.
[24′] Acornjs/acorn: A small, fast, javascript-based javascript parser, https://github.com/acornjs/acorn, (Accessed on Aug. 29, 2024), 2024.
[25′] Find and fix problems in your javascript code-eslint-pluggable javascript linter, [Accessed 2025-02-14]. [Online]. Available: https://eslint.org/.
[26′]B. Loring, D. Mitchell, and J. Kinder, “Expose: Practical symbolic execution of standalone javascript,” in Proceedings of the 24th ACM SIGSOFT International SPIN Symposium on Model Checking of Software, 2017, pp. 196-199.
[27′] Express—node.js web application framework, [Accessed 2025-02-28]. [Online]. Available: https://expressjs.com/.
[28′] Microsoft, Visual studio code—code editing. redefined, [Accessed 2025-02-28], November 2021. [Online]. Available: https://code.visualstudio.com/.
[29′] Jetstream 2.2, [Accessed 2025-02-28]. [Online]. Available: https://browserbench.org/JetStream/.
[30′] Speedometer 3.0, https://browserbench.org/Speedomete r3.0/, (Accessed on Sep. 1, 2024).
[31′]D. Cassel, N. Sabino, R. Martins, and L. Jia, “Nodemedic-fine: Automatic detection and exploit synthesis for node.js vulnerabilities,” in Proceedings of the 2025 Annual Network and Distributed System Security Symposium (NDSS), San Diego, CA, February 2025.
[32′] Chrome devtools protocol, [Online; accessed 20 Jan. 2022], 2022. [Online]. Available: https://chromedevtools.github.io/devtools-protocol/.

1. A non-transitory computer-readable medium having instructions stored thereon for a protection module configured to execute the instructions in a computer script interpretative engine, wherein the execution of the instructions, triggered when the computer script interpretative engine loads a computer script of an application program, causes a processor to:
prior to execution of the computer script by the computer script interpretative engine, receive a runtime abstract syntax tree (AST) profile of the computer script, wherein the runtime AST profile comprises a runtime AST structure associated with a set of runtime metadata;
select a learned AST profile from a candidate set of learned AST profiles, wherein each of the candidate set of learned AST profiles comprises a learned AST structure associated with a set of learned metadata, by matching (i) one or more metadata in the set of learned metadata of the learned AST profile with (ii) respective one or more metadata in the set of runtime metadata of the runtime AST profile;
compare (i) the runtime AST structure of the runtime AST profile and (ii) the learned AST structure of the selected learned AST profile; and
initiate or block execution of the computer script by the computer script interpretative engine based on the comparison.

2. The non-transitory computer-readable medium of claim 1, wherein the execution of the instructions further causes the processor to trigger a diagnostic operation to identify an entry point of an injection attack.

3. The non-transitory computer-readable medium of claim 1, wherein each of the runtime AST structure and the selected learned AST structure comprises a set of nodes and a set of edges connecting the nodes, wherein the set of nodes comprises (i) one or more executable-logic nodes, each representing an executable operation within the computer script, and/or (ii) one or more data nodes, each representing a data value within the computer script.

4. The non-transitory computer-readable medium of claim 3, wherein the execution of the instructions, during the comparison, causes the processor to:
compare (i) each executable-logic node of the runtime AST structure to a respective executable-logic node of the selected learned AST structure, and (ii) each data node of the runtime AST structure to a respective data node of the selected learned AST structure;
block the execution of the computer script by the computer script interpretative engine in response to:
a data node in the runtime AST structure and a respective data node in the selected learned AST structure representing data values of different data types;
an executable-logic node in the runtime AST structure and a respective executable-logic node in the selected learned AST structure representing different executable operations;
a data or executable-logic node in the runtime AST structure having a different number or arrangement of neighboring nodes from a respective data or executable-logic node in the selected learned AST structure.

5. The non-transitory computer-readable medium of claim 4, wherein the execution of the instructions, in response to no learned AST profiles from the candidate set of learned AST profiles being selected, causes the processor to:
receive a predefined set of security policies; and
initiate or block execution of the computer script by the computer script interpretative engine based on the received predefined set of security policies.

6. The non-transitory computer-readable medium of claim 5, wherein the set of runtime metadata specifies at least:
an execution environment for the computer script interpretative engine to execute the computer script therein,
a process in which the computer script interpretative engine loads the computer script, or
a combination thereof.

7. The non-transitory computer-readable medium of claim 6, wherein the received predefined set of security policies includes a first security policy causing the processor to block the execution of the computer script when the execution environment provides the computer script interpretative engine with access to an operating system of a host device of the computer script interpretative engine.

8. The non-transitory computer-readable medium of claim 7, wherein the received predefined set of security policies includes a second security policy causing the processor to block the execution of the computer script when an origin identifier associated with a runtime metadata mismatches a predefined origin identifier.

9. The non-transitory computer-readable medium of claim 8, wherein the received predefined set of security policies includes a third security policy causing the processor to block the execution of the computer script when one or more variables within the computer script utilize resources outside the computer script.

10. The non-transitory computer-readable medium of claim 5, wherein the candidate set of learned AST profiles was generated by parsing a set of computer scripts without executing the set of computer scripts.

11. The non-transitory computer-readable medium of claim 10, wherein the candidate set of learned AST profiles was further generated using runtime AST profiles generated by executions of the set of computer scripts.

12. The non-transitory computer-readable medium of claim 5, wherein the processor blocks the execution of the computer script by causing the computer script interpretative engine to return a non-operative function.

13. A system comprising:
a processor; and
a memory having instructions stored thereon for a protection module configured to execute the instructions in a computer script interpretative engine, wherein the execution of the instructions, triggered when the computer script interpretative engine loads a computer script of an application program, causes the processor to:
prior to execution of the computer script by the computer script interpretative engine, receive a runtime abstract syntax tree (AST) profile of the computer script, wherein the runtime AST profile comprises a runtime AST structure associated with a set of runtime metadata;
select a learned AST profile from a candidate set of learned AST profiles, wherein each of the candidate set of learned AST profiles comprises a learned AST structure associated with a set of learned metadata, by matching (i) one or more metadata in the set of learned metadata of the learned AST profile with (ii) respective one or more metadata in the set of runtime metadata of the runtime AST profile;
compare (i) the runtime AST structure of the runtime AST profile and (ii) the learned AST structure of the selected learned AST profile; and
initiate or block execution of the computer script by the computer script interpretative engine based on the comparison.

14. The system of claim 13, wherin each of the runtime AST structure and the selected learned AST structure comprises a set of nodes and a set of edges connecting the nodes, wherein the set of nodes comprises (i) one or more executable-logic nodes, each representing an executable operation within the computer script, and/or (ii) one or more data nodes, each representing a data value within the computer script.

15. The system of claim 14, wherein the execution of the instructions, during the comparison, causes the processor to:
compare (i) each executable-logic node of the runtime AST structure to a respective executable-logic node of the selected learned AST structure, and (ii) each data node of the runtime AST structure to a respective data node of the selected learned AST structure;
block the execution of the computer script by the computer script interpretative engine in response to:
a data node in the runtime AST structure and a respective data node in the selected learned AST structure representing data values of different data types;
an executable-logic node in the runtime AST structure and a respective executable-logic node in the selected learned AST structure representing different executable operations; or
a data or executable-logic node in the runtime AST structure having a different number or arrangement of neighboring nodes from a respective data or executable-logic node in the selected learned AST structure.

16. The system of claim 15, wherein the execution of the instructions, in response to no learned AST profiles from the candidate set of learned AST profiles being selected, causes the processor to:
receive a predefined set of security policies; and
initiate or block execution of the computer script by the computer script interpretative engine based on the received predefined set of security policies.

17. The system of claim 16, wherein the candidate set of learned AST profiles was generated by parsing a set of computer scripts without executing the set of computer scripts.

18. The system of claim 17, wherein the candidate set of learned AST profiles was further generated using runtime AST profiles generated by executions of the set of computer scripts.

19. A method for protecting a computer script interpretative engine prior to executing a computer script of an application program, the method comprising:
receiving a runtime abstract syntax tree (AST) profile of the computer script, wherein the runtime AST profile comprises a runtime AST structure associated with a set of runtime metadata;
selecting a learned AST profile from a candidate set of learned AST profiles, wherein each of the candidate set of learned AST profiles comprises a learned AST structure associated with a set of learned metadata, by matching (i) one or more metadata in the set of learned metadata of the learned AST profile with (ii) respective one or more metadata in the set of runtime metadata of the runtime AST profile;
comparing (i) the runtime AST structure of the runtime AST profile and (ii) the learned AST structure of the selected learned AST profile; and
initiating or blocking execution of the computer script by the computer script interpretative engine based on the comparison.

20. A non-transitory computer-readable medium to diagnose an application program during a runtime execution of the application program by a computer script interpretative engine, the computer-readable medium having instructions stored thereon, wherein execution of the instructions causes a processor to:
generate, in a first execution environment, an activity log of execution events invoked by function calls during the runtime execution of the application program;
in response to detecting a code injection attack during a partial execution path of the application program in the computer script interpretative engine, wherein the partial execution path of the application program generated a first call stack trace, reconstruct, in a second execution environment, a second call stack trace representing a full execution path of the application program, wherein the second call stack trace is reconstructed by correlating the generated activity log with the first call stack trace captured at a point of detection of the code injection attack;
generate, in the second execution environment, a self-contained application program of the application program, wherein the self-contained application program is generated based on the second call stack trace;
execute, in the second execution environment, the self-contained application program to obtain a quarantined execution path;
determine, via a root cause analysis operation, a program-entry point of the code injection attack in the quarantined execution path; and
output a diagnostic report that includes the program-entry point of the code injection attack in the quarantined execution path.

21-25. (canceled)
